(19) United States
(12) Patent Application Publication
(10) Pub. No.: US 2025/0056600 A1
(43) Pub. Date: Feb. 13, 2025

(54) SIDELINK COMMUNICATION VIA UNLICENSED CHANNEL OCCUPANCY TIME

(71) Applicant: Fraunhofer-Gesellschaft zur Förderung der angewandten Forschung e.V., München (DE)

(72) Inventors: Sarun SELVANESAN, Berlin (DE); Baris GÖKTEPE, Berlin (DE); Thomas FEHRENBACH, Berlin (DE); Thomas WIRTH, Berlin (DE); Thomas SCHIERL, Berlin (DE); Cornelius HELLGE, Berlin (DE)

(21) Appl. No.: 18/806,990

(22) Filed: Aug. 16, 2024

Related U.S. Application Data
(63) Continuation of application No. PCT/EP2023/053517, filed on Feb. 13, 2023.

(30) Foreign Application Priority Data
Feb. 18, 2022 (EP) 22157530.1

(51) Int. Cl. H04W 74/08; H04W 92/18

(52) U.S. Cl. CPC H04W 74/08; H04W 92/18

(57) ABSTRACT

A device configured for wirelessly transmitting a signal via a sidelink of a wireless communication network, e.g., 5G New Radio, includes a control unit configured for evaluating an availability of resources of the sidelink using an evaluation parameter. The control unit is configured to adapt the evaluation parameter.

### CROSS-REFERENCES TO RELATED APPLICATIONS

This application is a continuation of copending International Application No. PCT/EP2023/053517, filed Feb. 13, 2023, which is incorporated herein by reference in its entirety, and additionally claims priority from European Application No. EP 22 157 530.1, filed Feb. 18, 2022, which is incorporated herein by reference in its entirety.

### BACKGROUND OF THE INVENTION

The present application relates to the field of wireless communication systems or networks, more specifically to sidelink, SL; communications, more particularly to devices and methods for using sidelink unlicensed channel occupancy time.

FIG. 1 is a schematic representation of an example of a terrestrial wireless network 100 including, as is shown in FIG. 1A, the core network 102 and one or more radio access networks RAN₁, RAN₂, . . . . RAN_{N}. FIG. 1B is a schematic representation of an example of a radio access network RANₙ that may include one or more base stations gNB₁ to gNB₅, each serving a specific area surrounding the base station schematically represented by respective cells 106₁ to 106₅. The base stations are provided to serve users within a cell. The one or more base stations may serve users in licensed and/or unlicensed bands. The term base station, BS, refers to a gNB in 5G networks, an eNB in UMTS/LTE/LTE-A/LTE-A Pro, or just a BS in other mobile communication standards. A user may be a stationary device or a mobile device. The wireless communication system may also be accessed by mobile or stationary IoT devices which connect to a base station or to a user. The mobile or stationary devices may include physical devices, ground based vehicles, such as robots or cars, aerial vehicles, such as manned or unmanned aerial vehicles, UAVs, the latter also referred to as drones, buildings and other items or devices having embedded therein electronics, software, sensors, actuators, or the like as well as network connectivity that enables these devices to collect and exchange data across an existing network infrastructure. FIG. 1B shows an exemplary view of five cells, however, the RANₙ may include more or less such cells, and RANₙ may also include only one base station. FIG. 1B shows two users UE₁ and UE₂, also referred to as user device or user equipment, that are in cell 106₂ and that are served by base station gNB₂. Another user UE₃ is shown in cell 106₄ which is served by base station gNB₄. The arrows 108₁, 108₂ and 108₃ schematically represent uplink/downlink connections for transmitting data from a user UE₁, UE₂ and UE₃ to the base stations gNB₂, gNB₄ or for transmitting data from the base stations gNB₂, gNB₄ to the users UE₁, UE₂, UE₃. This may be realized on licensed bands or on unlicensed bands. Further, FIG. 1B shows two further devices 110₁ and 110₂ in cell 106₄, like IoT devices, which may be stationary or mobile devices. The device 110₁ accesses the wireless communication system via the base station gNB₄ to receive and transmit data as schematically represented by arrow 112₁. The device 110₂ accesses the wireless communication system via the user UEs as is schematically represented by arrow 112₂. The respective base station gNB₁ to gNB₅ may be connected to the core network 102, e.g. via the S1 interface, via respective backhaul links 114₁ to 114₅, which are schematically represented in FIG. 1B by the arrows pointing to “core”. The core network 102 may be connected to one or more external networks. The external network may be the Internet, or a private network, such as an Intranet or any other type of campus networks, e.g. a private WiFi communication system or a 4G or 5G mobile communication system. Further, some or all of the respective base station gNB₁ to gNB₅ may be connected, e.g. via the S1 or X2 interface or the XN interface in NR, with each other via respective backhaul links 116₁ to 116₅, which are schematically represented in FIG. 1B by the arrows pointing to “gNBs”. A sidelink channel allows direct communication between UEs, also referred to as device-to-device, D2D, communication. The sidelink interface in 3GPP is named PC5.

For data transmission a physical resource grid may be used. The physical resource grid may comprise a set of resource elements to which various physical channels and physical signals are mapped. For example, the physical channels may include the physical downlink, uplink and sidelink shared channels, PDSCH, PUSCH, PSSCH, carrying user specific data, also referred to as downlink, uplink and sidelink payload data, the physical broadcast channel, PBCH, carrying for example a master information block, MIB, and one or more system information blocks, SIBs, one or more sidelink information blocks, SLIBs, if supported, the physical downlink, uplink and sidelink control channels, PDCCH, PUCCH, PSSCH, carrying for example the downlink control information, DCI, the uplink control information, UCI, and the sidelink control information, SCI, and physical sidelink feedback channels, PSFCH, carrying PC5 feedback responses. The sidelink interface may support a 2-stage SCI which refers to a first control region containing some parts of the SCI, also referred to as the 1^{st} stage SCI, and optionally, a second control region which contains a second part of control information, also referred to as the 2^{nd} stage SCI.

For the uplink, the physical channels may further include the physical random-access channel, PRACH or RACH, used by UEs for accessing the network once a UE synchronized and obtained the MIB and SIB. The physical signals may comprise reference signals or symbols, RS, synchronization signals and the like. The resource grid may comprise a frame or radio frame having a certain duration in the time domain and having a given bandwidth in the frequency domain. The frame may have a certain number of subframes of a predefined length, e.g. 1 ms. Each subframe may include one or more slots of 12 or 14 OFDM symbols depending on the cyclic prefix, CP, length. A frame may also have a smaller number of OFDM symbols, e.g., when utilizing shortened transmission time intervals, sTTI, or a mini-slot/non-slot-based frame structure comprising just a few OFDM symbols.

The wireless communication system may be any single-tone or multicarrier system using frequency-division multiplexing, like the orthogonal frequency-division multiplexing, OFDM, system, the orthogonal frequency-division multiple access, OFDMA, system, or any other Inverse Fast Fourier Transform, IFFT, based signal with or without Cyclic Prefix, CP, e.g. Discrete Fourier Transform-spread-OFDM, DFT-s-OFDM. Other waveforms, like non-orthogonal waveforms for multiple access, e.g., filter-bank multicarrier, FBMC, generalized frequency division multiplexing, GFDM, or universal filtered multi carrier, UFMC, may be used. The wireless communication system may operate, e.g., in accordance with the LTE-Advanced pro standard, or the 5G or NR, New Radio, standard, or the NR-U, New Radio Unlicensed, standard.

The wireless network or communication system depicted in FIG. 1 may be a heterogeneous network having distinct overlaid networks, e.g., a network of macro cells with each macro cell including a macro base station, like base station gNB₁ to gNB₅, and a network of small cell base stations, not shown in FIG. 1, like femto or pico base stations. In addition to the above described terrestrial wireless network also non-terrestrial wireless communication networks, NTN, exist including spaceborne transceivers, like satellites, and/or airborne transceivers, like unmanned aircraft systems. The non-terrestrial wireless communication network or system may operate in a similar way as the terrestrial system described above with reference to FIG. 1, for example in accordance with the LTE-Advanced Pro standard or the 5G or NR, new radio, standard.

In mobile communication networks, for example in a network like that described above with reference to FIG. 1, like a LTE or 5G/NR network, there may be UEs that communicate directly with each other over one or more sidelink, SL, channels, e.g., using the PC5/PC3 interface or WiFi direct. UEs that communicate directly with each other over the sidelink may include vehicles communicating directly with other vehicles, V2V communication, vehicles communicating with other entities of the wireless communication network, V2X communication, for example roadside units, RSUs, roadside entities, like traffic lights, traffic signs, or pedestrians. An RSU may have a functionality of a BS or of a UE, depending on the specific network configuration. Other UEs may not be vehicular related UEs and may comprise any of the above-mentioned devices. Such devices may also communicate directly with each other, D2D communication, using the SL channels. When considering two UEs directly communicating with each other over the sidelink, e.g., using the PC5/PC3 interface, one of the UEs may also be connected with a BS, and may relay information from the BS to the other UE via the sidelink interface and vice-versa. The relaying may be performed in the same frequency band, in-band-relay, or another frequency band, out-of-band relay, may be used. In the first case, communication on the Uu and on the sidelink may be decoupled using different time slots as in time division duplex, TDD, systems.

FIG. 2 is a schematic representation of an in-coverage scenario in which two UEs directly communicating with each other are both connected to a base station. The base station gNB has a coverage area that is schematically represented by the circle 200 which, basically, corresponds to the cell schematically represented in FIG. 1. The UEs directly communicating with each other include a first vehicle 202 and a second vehicle 204 both in the coverage area 200 of the base station gNB. Both vehicles 202, 204 are connected to the base station gNB and, in addition, they are connected directly with each other over the PC5 interface. The scheduling and/or interference management of the V2V traffic is assisted by the gNB via control signaling over the Uu interface, which is the radio interface between the base station and the UEs. In other words, the gNB provides SL resource allocation configuration or assistance for the UEs, and the gNB assigns the resources to be used for the V2V communication over the sidelink. This configuration is also referred to as a mode 1 configuration in NR V2X or as a mode 3 configuration in LTE V2X.

FIG. 3 is a schematic representation of an out-of-coverage scenario in which the UEs directly communicating with each other are either not connected to a base station, although they may be physically within a cell of a wireless communication network, or some or all of the UEs directly communicating with each other are connected to a base station but the base station does not provide for the SL resource allocation configuration or assistance. Three vehicles 206, 208 and 210 are shown directly communicating with each other over a sidelink, e.g., using the PC5 interface. The scheduling and/or interference management of the V2V traffic is based on algorithms implemented between the vehicles. This configuration is also referred to as a mode 2 configuration in NR V2X or as a mode 4 configuration in LTE V2X. As mentioned above, the scenario in FIG. 3 which is the out-of-coverage scenario does not necessarily mean that the respective mode 2 UEs in NR or mode 4 UEs in LTE are outside of the coverage 200 of a base station, rather, it means that the respective mode 2 UEs in NR or mode 4 UEs in LTE are not served by a base station, are not connected to the base station of the coverage area, or are connected to the base station but receive no SL resource allocation configuration or assistance from the base station. Thus, there may be situations in which, within the coverage area 200 shown in FIG. 2, in addition to the NR mode 1 or LTE mode 3 UEs 202, 204 also NR mode 2 or LTE mode 4 UEs 206, 208, 210 are present. In addition, FIG. 3, schematically illustrates an out of coverage UE using a relay to communicate with the network. For example, the UE 210 may communicate over the sidelink with UE 212 which, in turn, may be connected to the gNB via the Uu interface. Thus, UE 212 may relay information between the gNB and the UE 210

Although FIG. 2 and FIG. 3 illustrate vehicular UEs, it is noted that the described in-coverage and out-of-coverage scenarios also apply for non-vehicular UEs. In other words, any UE, like a hand-held device, communicating directly with another UE using SL channels may be in-coverage and out-of-coverage.

In a wireless communication system as described above with reference to FIG. 1, FIG. 2 or FIG. 3, a UE communicating over the sidelink may optionally operate in a discontinuous reception, DRX, mode.

Starting from the conventional technology as described above, there may be a need for enhancements or improvements for a UE communicating over the sidelink.

### SUMMARY

An embodiment may have a device configured for wirelessly transmitting a signal via a sidelink of a wireless communication network, e.g., 5G New Radio, the device comprising: a control unit configured for evaluating an availability of resources of the sidelink using an evaluation parameter, wherein the control unit is configured to adapt the evaluation parameter.

Another embodiment may have a wireless communication network comprising a device according to the invention.

### BRIEF DESCRIPTION OF THE DRAWINGS

Embodiments of the present invention will be detailed subsequently referring to the appended drawings, in which:

FIG. 1A-B show a schematic representation of an example of a wireless communication system;

FIG. 2 is a schematic representation of an in-coverage scenario in which two UEs directly communicating with each other are both connected to a base station;

FIG. 3 is a schematic representation of an out-of-coverage scenario in which the UEs directly communicate with each other;

FIG. 4A-C show schematic representations of a process for sensing a sidelink, SL;

FIG. 5 shows a schematic illustration of a device according to an embodiment;

FIG. 6A shows a schematic timeline representing time prior to which a contention window is located according to an embodiment;

FIG. 6B shows a schematic diagram of a non-contiguous evaluation window according to an embodiment;

FIG. 7 shows a configuration of contention windows for a Channel Access Priority Class (CAPC) in Mode 1;

FIG. 8A-B show schematic representations of resource pool configurations according to embodiments;

FIG. 9 shows a schematic illustration of a competitive situation of UEs aiming for transmission according to an embodiment;

FIG. 10A-E show example configurations of forming code block groups according to embodiments;

FIG. 11A-C show schematic representations for illustrating a concept of partial acknowledging according to embodiments;

FIG. 12A-C shows a schematic block diagram illustrating a cooperation of three UEs according to an embodiment of the second aspect;

FIG. 13 shows a schematic diagram illustrating a COT distribution among UEs by another according to an embodiment;

FIG. 14 shows pseudo code for illustrating an example structure of a configuration signal according to an embodiment;

FIG. 15 shows a schematic representation of multiple subbands that are subject to sharing a COT according to an embodiment;

FIG. 16 is a schematic representation of a wireless communication system including a transmitter, like a base station, and one or more receivers, like user devices or UEs, capable of operating in accordance with embodiments of the present invention; and

FIG. 17 illustrates an example of a computer system on which units or modules as well as the steps of the methods described in accordance with the inventive approach may execute.

### DETAILED DESCRIPTION OF THE INVENTION

Embodiments of the present invention are now described in more detail with reference to the accompanying drawings in which the same or similar elements have the same reference signs assigned.

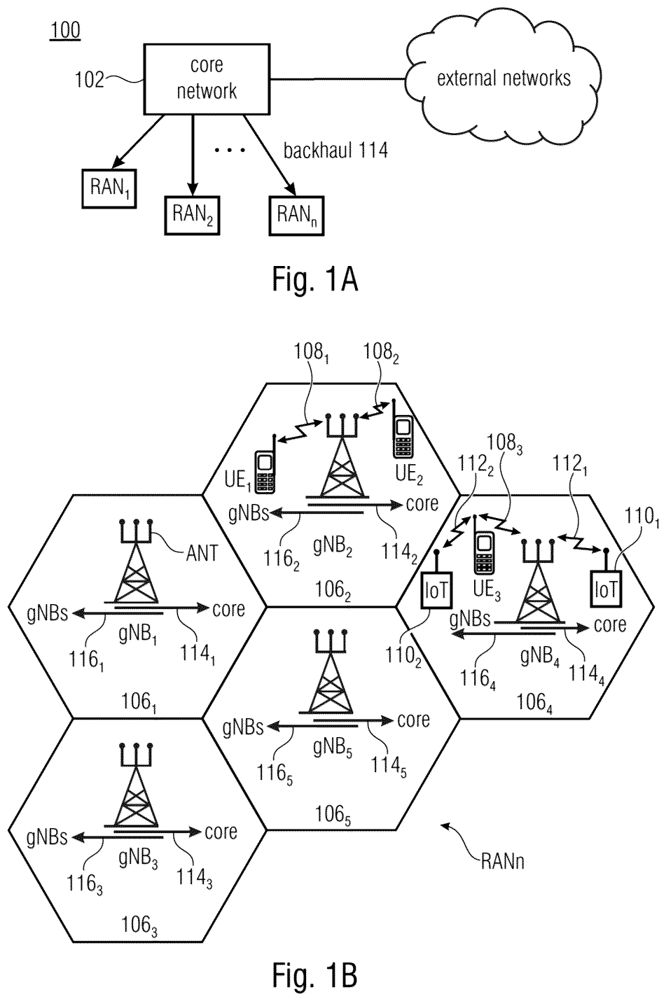

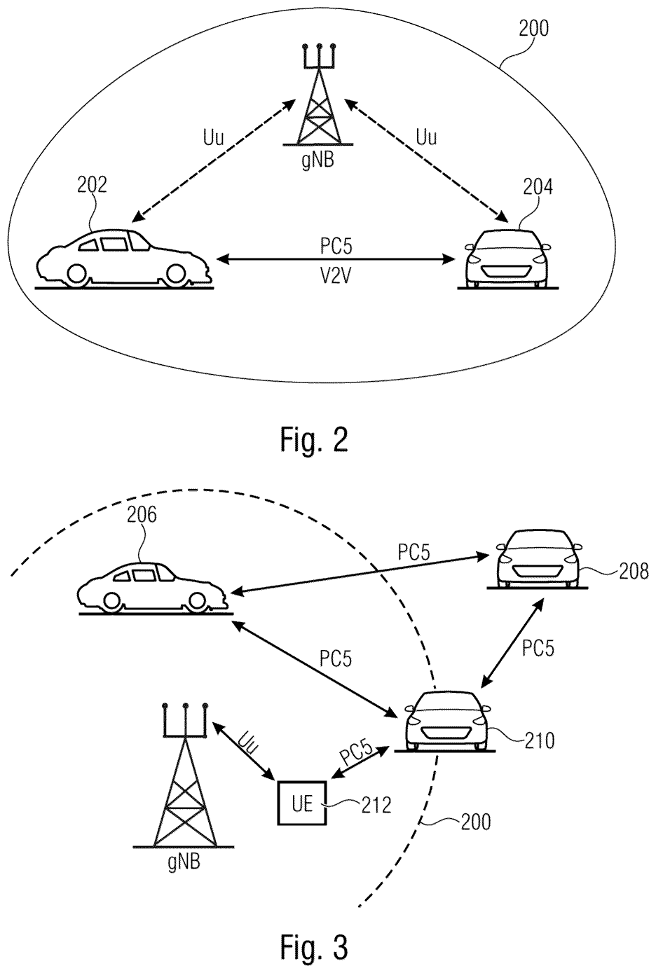

In the wireless communication system or network, like the one described above with reference to FIG. 1, FIG. 2 or FIG. 3, a sidelink communication among the respective user devices may be implemented, for example, a vehicle-to-vehicle communication, V2V, a vehicle-to-anything communication, V2X, or any device-to-device communication, D2D, among any other use devices, for example, those mentioned above.

Whilst making reference to the non-limiting example of V2X communication, the initial vehicle-to-everything (V2X) specification was included in Release 14 of the 3GPP standard. The scheduling and assignment of resources have been modified according to the V2X requirements, while the original device-to-device (D2D) communication standard has been used as the basis of the design. Release 15 of the LTE V2X standards (also known as enhanced V2X or eV2X) was completed in June 2018, and Release 16, the first release of 5G NR V2X, was completed in March 2020. Release 17 focuses on sidelink enhancements, with emphasis on power saving, enhanced reliability and reduced latency, to cater to not only vehicular communications, but also public safety and commercial use cases. Release 18 will focus on implementing sidelink in the unlicensed spectrum.

### Rel-16 Sidelink Sensing Procedure

In NR V2X, Mode 2 as described in Release 16 with respect to the sidelink sensing procedure and the NR-unlicensed channel access procedure UEs are expected to carry out resource allocation autonomously. These UEs do not receive any assistance from the gNB, in the form of dynamic or configured grants, nor from any other source. Typically, they carry out sensing to determine available resources that can be used for their own transmissions instead. UEs autonomously select resources in the following steps:
Sensing within a sensing window, by comparing the Reference Signal Received Power, RSRP, measured in a resource within the sensing window to an RSRP threshold. This threshold is derived from using the priority of the intended transmission by a UE, and the priority of a transmission received in an SCI in the resource.
Exclusion of resources reserved by other UEs.
Selection of final resources within a selection window.

Note that NR Release 17 sidelink introduces a mode where V2X UEs (VUEs) can also perform random resource selection. This might be limited to certain resources, e.g., a partition N which is a subset of resources of a resource pool, or resource pools, e.g., the exceptional resource pool. In addition, this can also be linked to a priority threshold, which is then configured or preconfigured per resource pool or resource pool partition, e.g., traffic with low priority will be allowed to be send via random resource selection in a resource pool or resource pool partition which allows traffic of this said priority. On the contrary, resource pool partitions or resource pool can be configured with a high priority threshold, which would prevent UEs from transmitting with random resource selection. This is done in order to reduce interference within resource pools as well as to protect high priority transmissions, and avoid that resource pools become congested. Furthermore, Release 17 sidelink specifies inter-UE communication (IUC) techniques, which allow to exchange preferred or non-preferred resources as well as collision indications, so that consecutive collisions are avoided.

### Sensing Window

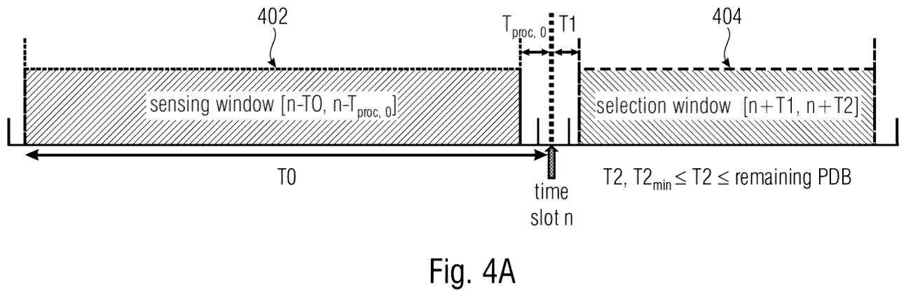

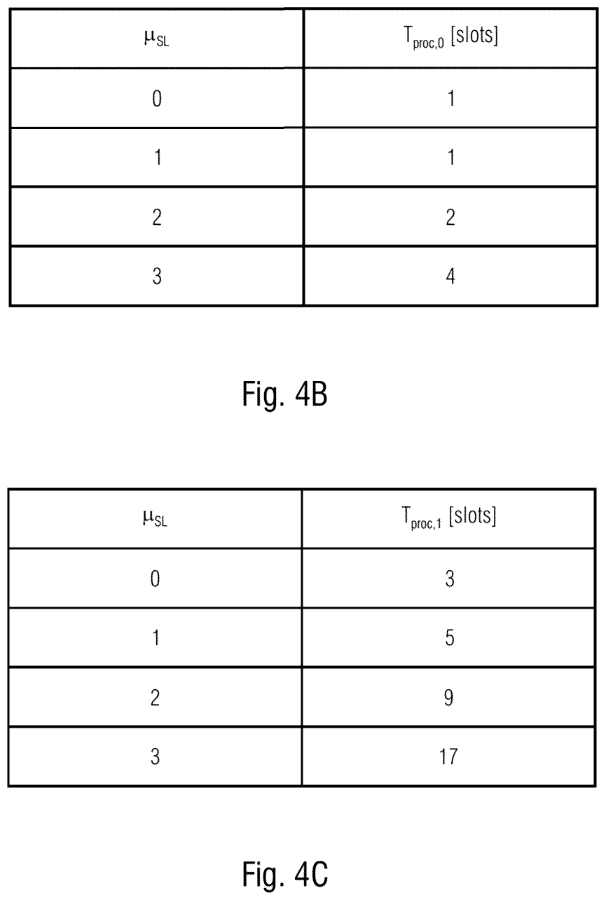

The process of sensing is where a Mode 2 UE takes into account the first stage SCIs received from other UEs in order to identify resources that have been reserved by these other UEs in the recent past. It also measures the SL RSRP in time slots to determine the interference levels if the UE were to transmit in these resources. This would enable the UE to identify available resources for its transmissions. The process is depicted in FIG. 4A showing a schematic representation of the sensing process, with the sensing window 402 and selection window 404.

When a Mode 2 UE such as a UE of FIG. 1B or a vehicle of FIG. 2 or FIG. 3 intends to carry out a transmission, the process of resource selection is triggered, where the UE considers the sensing results over a time period in the past, prior to the triggering of the resource selection. The sensing window 402 is the time period within which a UE considers the sensing results in order to determine the possible resources for a transmission, at time slot n.

This sensing window 402 commences either 1100 ms or 100 ms in the past, T0, and concludes shortly before the process is triggered, T_{proc,0}. The sensing window 402 is defined by [n−T0, n−T_{proc,0}].
T0 is defined by the higher layers (Resource Pool, RP, configuration), by the parameter sl-SensingWindow-r16, and can take values between 100 ms to 1100 ms

T_{proc,0} is defined by the table shown in FIG. 4B, with respect to the subcarrier spacing used for the resource pool.

The results generated from the process are called sensing results. Sensing results are essentially a set of time and frequency resources that can indicate whether certain resources are available/unavailable. These indicated resources are within a specific resource pool, spread over a specific duration of time (start and end time) in the past, within the sensing window 402.

### Selection Window

Using this information, the UE selects resources within a selection window 404 in FIG. 4A, which begins shortly after the resource selection trigger, T1, and its end, T2, is determined by the packet delay budget associated with the packet due to be transmitted. The selection window 404 is the time period within which a UE selects resources by taking into account the sensing information, extrapolates the available resources based on the sensing information, and selects resources for its own transmissions.

The selection window is defined by [n+T1, n+T2], where T1 and T2 are up to UE implementation, with the following constraints:
T1 is defined as 0≤T1≤T_{proc,1}, where T_{proc,1} is defined by the table shown in FIG. 4C, with respect to the subcarrier spacing used for the resource pool.
T2 is defined based on the packet delay budget and T2ₘᵢₙ, which is defined by the higher layers (RP configuration), by the parameter sl-SelectionWindow-r16, and can take values between 1, 5, 10 and 20 ms, depending on the priority of the packet to be transmitted.
   if T2<remaining PDB, T2ₘᵢₙ≤T2≤remaining PDB
   else, T2=remaining PDB

If a resource within this window is deemed to be below an SL RSRP threshold, which is determined by the priority of the packet to be transmitted and the SCI received in the given resource, the resource is included into a candidate resource set. A candidate resource set consists of a set of time and frequency resources that can indicate whether certain resources are available/unavailable. These indicated resources are within a specific resource pool, spread over a specific duration of time (start and end time) in the future, within the selection window.

In the case that the resources in the candidate resource set is below a certain percentage with respect to the resources within the selection window, the UE then proceeds to relax the SL RSRP threshold that was previously used, in steps of 3 dB. The percentage of available resources is associated with the priority of the intended transmission. Once the required size of the candidate resource set is achieved, the UE then randomly selects resources from the populated candidate resource set for the transmission of the packet.

### Rel-16 NR-U Channel Access Procedure

A channel access procedure is a procedure based on sensing that evaluates the availability of a channel for performing transmissions. The basic unit for sensing is a sensing slot with a duration Tₛᵢ=9 μs. The sensing slot duration Tₛᵢ is considered to be idle if an eNB/gNB or a UE senses the channel during the sensing slot duration, and determines that the detected power for at least 4 μs within the sensing slot duration is less than energy detection threshold X_{Thresh}. Otherwise, the sensing slot duration Tₛᵢ is considered to be busy.

A channel occupancy refers to transmission(s) on channel(s) by eNB/gNB/UE(s) after performing the corresponding channel access procedures in this clause.

A channel occupancy time refers to the total time for which eNB/gNB/UE and any eNB/gNB/UE(s) sharing the channel occupancy perform transmission(s) on a channel after an eNB/gNB/UE performs the corresponding channel access procedures described above. For determining a Channel Occupancy Time, if a transmission gap is less than or equal to 25 μs, the gap duration is counted in the channel occupancy time. A channel occupancy time can be shared for transmission between an eNB/gNB and the corresponding UE(s).

### Channel Access Procedure for Type 1

The eNB/gNB may transmit a transmission after first sensing the channel to be idle during the sensing slot durations of a defer duration T_{d} and after the counter N is zero in step 4 below. The counter N is adjusted by sensing the channel for additional sensing slot duration(s) according to the steps below:
Step 1) set N=Nᵢₙᵢₜ, where Nᵢₙᵢₜ is a random number uniformly distributed between 0 and CWₚ, and go to step 4;
Step 2) if N>0 and the eNB/gNB chooses to decrement the counter, set N=N−1;
Step 3) sense the channel for an additional sensing slot duration, and if the additional sensing slot duration is idle, go to step 4; else, go to step 5;
Step 4) if N=0, stop; else, go to step 2.
Step 5) sense the channel until either a busy sensing slot is detected within an additional defer duration Td or all the sensing slots of the additional defer duration Td are detected to be idle;
Step 6) if the channel is sensed to be idle during all the sensing slot durations of the additional defer duration Td, go to step 4; else, go to step 5;

If an eNB/gNB has not transmitted after step 4 in the procedure above, the eNB/gNB may transmit on the channel, if the channel is sensed to be idle at least in a sensing slot duration Tₛₜ when the eNB/gNB is ready to transmit and if the channel has been sensed to be idle during all the sensing slot durations of a defer duration T_{d} immediately before this transmission. If the channel has not been sensed to be idle in a sensing slot duration Tₛₜ when the eNB/gNB first senses the channel after it is ready to transmit or if the channel has been sensed to be not idle during any of the sensing slot durations of a defer duration T_{d} immediately before this intended transmission, the eNB/gNB proceeds to step 1 after sensing the channel to be idle during the sensing slot durations of a defer duration T_{d}.

The defer duration T_{d} consists of duration T_{f}=16 μs immediately followed by mₚ consecutive sensing slot durations Tₛₜ, and T_{f} includes an idle sensing slot duration Tₛₜ at start of T_{f}.

Starting from this, embodiments provide for advantageous solutions for sensing the channel when operating in a mode 2, i.e., when using the sidelink.

According to a first aspect of the embodiments presented herein, the inventors have discovered that devices may benefit from adopting an evaluation parameter when sensing the channel to evaluate an availability of resources in the sidelink. Adapting the evaluation parameters allows for efficient usage of the channel and/or to implement service-specific features such as a consideration of priority and/or packet delay budget, PDB.

According to a second aspect of the present disclosure, the inventors have discovered that the channel occupancy time, COT, granted or associated with occupying the channel may be distributed between different entities so as to allow to avoid unnecessary idle time in the channel when devices wait for a predefined COT to end and/or to have a low number of sensing windows.

Both aspects are connected to each other by the inventive idea to efficiently use the sidelink and to improve sensing on the sidelink.

According to an embodiment related to the first aspect, a device configured for wirelessly transmitting a signal via a sidelink of a wireless communication network comprises a control unit for evaluating an availability of resources of the sidelink using an evaluation parameter. The control unit is configured to adapt the evaluation parameter.

Adapting the evaluation parameters may relate to considering the signal to be transmitted and/or a condition of the sidelink and/or other circumstances to adapt the evaluation parameter to aim for an efficient sensing procedure.

According to an embodiment of the second aspect, a device is presented that is configured to wirelessly transmitting a signal via a sidelink of a wireless communication network. The device is configured for sharing a granted channel occupancy time, COT, for the sidelink with another device of the wireless communication network. Such a sharing may, for example, rely on receiving information that the device is also instructed to use the COT, e.g., when the other device has ended its transmission and/or to pass over, implicitly and/or explicitly, a remaining channel occupancy time to the other device.

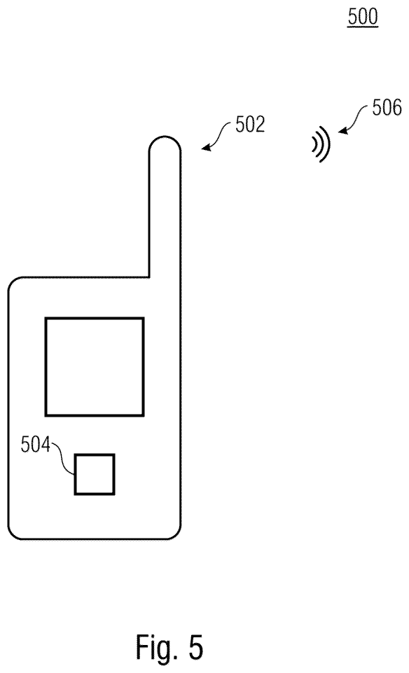

FIG. 5 shows a schematic illustration of a device 500 according to an embodiment, wherein the device 500 may operate according to the first aspect and/or according to the second aspect. The device 500 may be in accordance with the description presented in connection with the UEs of FIG. 1B, with a vehicle of FIGS. 2 and/or 3 or may operate differently therefrom. The device 500 may comprise an antenna unit 502 configured for transceiving signals via the sidelink in a wireless communication network such as 5G new radio networks, wherein the embodiments presented herein are not limited hereto but may operate also, for example, on other sidelinks in a wireless communication network such as 6G or the like.

The device 500 comprises a control unit 504. For transmitting a signal 506 on the sidelink, e.g., PC5, the device, or more particularly, control unit 504 may evaluate an availability of resources of the sidelink. Such an evaluation may relate, for example, to a transmission requirement of the signal to be transmitted and/or may relate to an occupancy of resources of the sidelink. For example, the control unit 504 may adapt a contention window used for sensing occupancy of the sidelink. Alternatively or in addition, the control unit 504 may evaluate a transmission requirement such as a priority or priority class of a signal or a content thereof. Alternatively or in addition, alternative information, for example, related to received information such as information received with an assistance information message, AIM, may lead to an adaptation of the evaluation parameter.

The device 500 may operate in a wireless communication network in which the sidelink of the device is associated with a frequency band such as the industrial, scientific and medical, ISM, band or other parts of the frequency spectrum. Operation in such frequency bands may require the device to perform a listen before talk, LBT, procedure before transmitting in the frequency band. Such a requirement may result, for example, from a regulation such as an ETSI BRAN regulation (BRAN=broadband radio access networks). Such a listen before talk procedure may incorporate the use of a so-called contention window, CW, during which the sidelink is sensed. According to some embodiments related to the first aspect, the evaluation parameter to be adapted by the control unit 504 is associated with such a contention window.

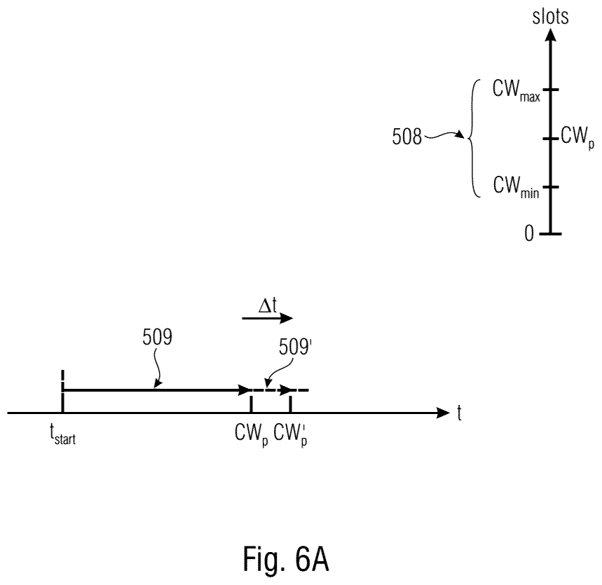

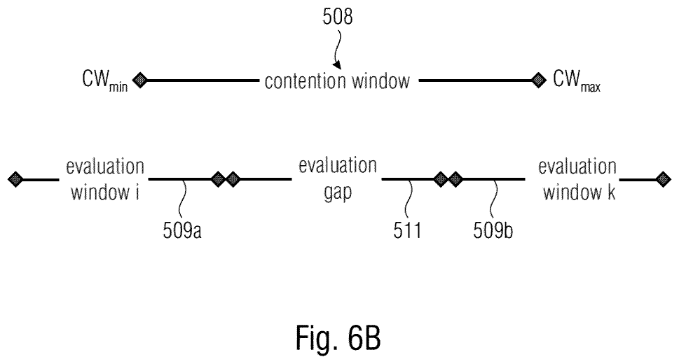

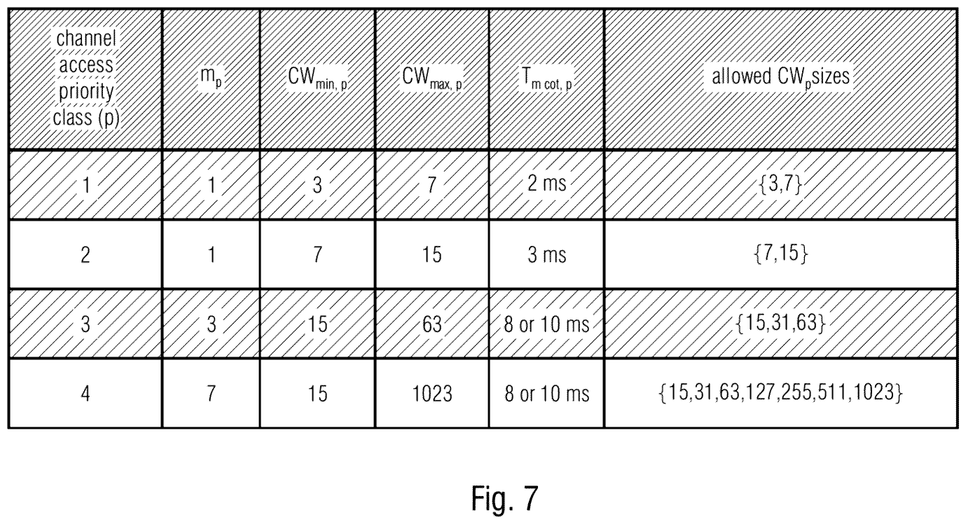

FIG. 6A shows a schematic illustration of a contention window 508. The contention window 508 may define a lower limit CWₘᵢₙ≥ZERO of slots or an different time-related unit and an upper limit CWₘₐₓ>CWₘᵢₙ. A device aiming for transmission may be adapted to select a random number CWₚ within the contention window 508 and may wait until the channel has been determined idle for the time associated with the random number. In case, the channel is actually idle, this may result in a waiting time during a listening window or evaluation window 509 being the time associated with CWₚ. For example, the device may increment/decrement a counter associated with CWₚ for each idle slot until the counter has reached a predetermined value such as ZERO. However, if the channel is busy during the listening window 509, the total time of waiting may increase by time Δt, e.g., based on the counter taking a longer time until reaching the predetermined value. That is, the contention window 508 may comprise a contention window setting, the setting comprising a lower limit CWₘᵢₙ and an upper limit CWₘₐₓ. Adapting the contention window may be related with adapting at least one, the lower limit CWₘᵢₙ and/or the upper limit CWₘₐₓ. In other words, the contention window (setting) is picked from a set of CWs (settings). Each CW is an interval [CWₘᵢₙ, CWₘₐₓ]. For the backoff, listening time, a random number is drawn from the CW. An example is shown in FIG. 7. According to an embodiment, the control unit 504 may be configured for adapting the contention window setting when adapting the evaluation parameter. For example, the control unit 504 may adapt at least one of a contention time of the contention window, a power threshold, e.g., based on a channel busy ratio, CBR, and/or including information on the interference, e.g., using reference signal received power, RSRP, reference signal received quality, RSRQ, a signal to interference plus noise ratio, SINR, an interference power or the like. Alternatively or in addition, adapting the evaluation parameter may relate to one of a detection of a preamble, e.g., a preamble of a WiFi system, or demodulation reference signals, DMRS, transmitted from another device, e.g., in new radio or LTE or the like.

However, the time duration calculated from drawing a random number from the contention window may be referred to as listening window or evaluation window. The evaluation window may be contiguous as indicated in FIG. 6A or, as shown, for example, in FIG. 6B non-contiguous, and may provide for an integral or a distributed evaluation time referred to as evaluation window. According to FIG. 6B, evaluation is performed by the device during evaluation windows 509a and 509b being spaced in time by an evaluation gap 511 A number of such spaced evaluation windows may be 2 or more, e.g., 3, 4, 5 or more. In FIG. 6B there is further shown the contention window 508 of FIG. 6A. Adapting the evaluation parameter may relate to monitoring the resources during an evaluation window 509, i.e., at least a part of the contention window or at least one or a plurality of evaluation windows 509a, 509b, . . . . Therein, a start time and/or a length and/or an end time of the evaluation window, an evaluation periodicity such as a number and/or distribution of at least one evaluation window and/or the condition whether the evaluation window is contiguous or non-contiguous in the contention window, whether the evaluation windows are contiguous or non-contiguous respectively may be considered, and/or adapted.

The evaluation parameter may be a single parameter that is adapted, e.g., a contention window length. Alternatively, the evaluation parameter may be one of a plurality or a set of evaluation parameters from which one, some or all are adapted when adapting the evaluation of the availability of resources of the sidelink. For example, the start time of a contention window may be changed together with a duration thereof and/or the duration together with an end time of the contention window.

According to an embodiment, the control unit may be configured for selecting the evaluation parameter or the set of evaluation parameters as one of a plurality of candidates. The selected candidate may comprise the evaluation parameters.

After having finished the determination of available resources, the device may select resources for transmission based on the evaluation and/or transmit the signal 506 using the identified resources.

### Idea 1: Contention Window Size determined by Random Number Generator based on a Criteria

### Problem

As per state of the art, SoTA, each UE operating in Mode 1 selects a random duration of contention window size between 0 and CWₚ to carry out Type 1 LBT to check whether the channel is available or not.
The contention window size is currently pre-configured, and is already linked to priority in a way.
CW_{min,p}≤CWₚ≤CW_{max,p} is the contention window.
CW_{min,p} and CW_{max,p} are chosen before step 1 of the procedure described in connection with the channel access procedure above.
mₚ, CW_{min,p} and CW_{max,p} are based on a channel access priority class p associated with the eNB/gNB transmission, as shown in FIG. 7.
An eNB/gNB shall not transmit on a channel for a Channel Occupancy Time that exceeds T_{m cot,p} where the channel access procedures are performed based on a channel access priority class associated with the eNB/gNB transmissions, as given in the table of FIG. 7 showing a configuration of contention windows for a Channel Access Priority Class (CAPC) in Mode 1.
If the channel is available, the UE will use the channel for the defined channel occupancy time (COT), while the other UEs will then reset their timer and carry out Type 1 LBT.
If a UE in the previous COT had a large number of negative acknowledgements, NACKs, (above a pre-defined threshold), then the UE will increase the contention window size.

Embodiments described herein relate to transmission of signals on the sidelink, to Mode 2.

According to an embodiment, the sidelink comprises, according to a configuration of the wireless communication network,
one or more resource pools, RPs, e.g., transmit, receive or exceptional resource pools, or
one or more bandwidth parts, BWPs, or
one or more frequency entities, or
one or more time entities, e.g., OFDM symbols or slots or subframes or radioframes etc.

According to an embodiment, the sidelink comprises a set of frequency entities according to a configuration of the wireless communication network, the frequency entities indicated by at least one of:
a bitmap, the bitmap indicating resources, like resource blocks, across the one BWP,
a vector, such as a frequency index vector (FRIV),
a starting resource, like a resource block, and a number of resources for a resource set,
multiple starting resources, like resource blocks, and ending resources, if the resource set is non-contiguous over frequency,
explicit resource indices, like resource block indices,
puncturing out resources mentioned explicitly or that are part of another set of resources or RP,
a starting resource, and periodic offsets for subsequent occurrences,
a pattern of resource blocks or subchannels

According to an embodiment, the sidelink comprises a set of time entities according to a configuration of the wireless communication network, the time entities indicated by at least one of:
a bitmap across time, the bitmap indicating resources, like OFDM symbols or time slots or subframes or frames, where the resource set is defined, spanning either a portion or the entire length of the one BWP,
a vector, such as a time index vector (TRIV),
a starting resource, like a time slot or a subframe, and a duration of the resource set,
explicit resources numbers, like time slot or subframe numbers,
puncturing out resources mentioned explicitly or that are part of another set of resources or RP,
a starting resource, and periodic offsets for subsequent occurrences,
a pattern of symbols, time slots or subframes or frames.

Some embodiments are described in connection with signals having a high priority or priority class and/or with signals that are associated with a low packet delay budget, PDB, e.g., they have to be delivered urgently, which can be also mapped to the term priority in a broader sense. However, as an alternative or in addition other parameters may influence the decisions described herein, e.g., an occupancy of the sidelink that may lead to unsuccessful earlier tries to transmit a signal due to collisions and/or a channel status/quality that may lead to unsuccessful transmissions. Alternatively or in addition, a received message or configuration information such as an assistance information message, AIM and/or an inter-UE communication (IUC) coordination message may provide for information to indicate how to adapt the sensing of the SL. That is, even if referring to a priority or priority class in connection with description presented herein, the embodiments are not limited to such a transmission requirement parameter hereto but can also rely, without limitation, as an alternative or in any combination:
a remaining packet delay budget (PDB),
one or a number of unsuccessful previous transmissions,
one or a number of detected collisions
a received assistance information message (AIM) such as an inter-UE coordination information message (IuC),
a cast type (e.g., unicast, groupcast, broadcast) of the signal message or packet (control/data/feedback),
a zone ID or geolocation or minimum required communication range (MCR),
a transmission type, as the transmission requirement.

From the above, the transmission type may relate to at least one of:
a data transmission,
a control transmission,
a feedback transmission such as a HARQ information or collision indicator (CI) information,
an inter-UE coordination (IuC) information message transmission,
a synchronization signal transmission.

### Solution 1: Selection of Minimum/Maximum CW Size

To prioritize the timer duration based on the priority of the transmission, embodiments propose that a UE with higher priority transmissions will use shorter durations to carry out LBT, so that it has a higher chance of gaining access to the channel as compared to other UEs having lower priority transmissions. Hence, we want to set the random number generator to be a function of the priority of the intended transmission by a UE. This would require
A mapping between SL-priorities and channel access classes,
A resource pool configuration that links SL-priority to channel access classes.

For this, traffic streams of different priority can be mapped to different logical channels, each having a logical channel identifier (LCID), which are then mapped to different LBT configurations. In a further embodiment, the selection of the minimum and/or maximum length of the contention window (CW) can also be linked to a total or remaining packet delay budget (PDB). Depending on the PDB, the UE selects from a different set of CWₘᵢₙ and/or CWₘₐₓ. Other criteria (than SL-priority or PDB) which can be taking into account could be one or more of the following parameters, as described above:
Remaining packet delay budget, e.g., if below a threshold, the CW is adapted for the current and/or future transmissions,
Unsuccessful previous transmissions (received or missed NACKs),
Detected collisions, e.g., high collisions would lead to an increase of CWₘᵢₙ/CWₘₐₓ, low number of collisions would lead to a decrease of CWₘᵢₙ/CWₘₐₓ
Received assistance information message (AIMs).

In the latter case, a UE can receive an AIM from another UE or from an RSU or a gNB, which would then trigger the UE to adapt its CWₘᵢₙ/CWₘₐₓ values to adjust its LBT to the current channel usage.

That is, the control unit 504 may be configured for selecting the evaluation parameter or a priority class, e.g., with respect to the definition of ETSI BRAN, based on a transmission requirement parameter associated with the signal. For example, the priority class may be in accordance with the channel access constraints defined within the ETSI BRAN specification. A packet may be associated with a priority tag, which can then be transported using the channel access constraints of ETSI BRAN. The packet priority can be used to select the ETSI BRAN priority class, but also other criteria, e.g. PDB or cast-type etc. can play a role here.

The transmission requirement parameter and/or the evaluation parameter or priority class may be based on at least one of a priority of a packet (such as control/data/feedback) or the signal to be transmitted, a packet delay budget of the packet or the signal, an unsuccessful prior attempt to transmit the packet or the signal, a detected collision during a prior transmission, e.g., a prior transmission that has used the same resources when compared to the analyzed ones, a conflict in a future transmission, e.g., detected via feedback of other UEs, a received AIM that may be an inter-UE coordination information message (IuC). Alternatively or in addition, the selection of the evaluation parameter may be based on a cast type of the packet, geographical information such as a zone ID or geolocation or minimum required communication range (MCR) and/or a transmission type.

When referring to the evaluation parameter as relating to the duration of a contention window and the priority class so as to form a basis for the decision, embodiments allow for a control unit that selects the evaluation parameter to select a time duration of the contention window used for evaluating the availability based on the priority class. In one aspect, the control unit may select a first time duration for a first signal having a first priority and for selecting a second, shorter time duration for a second signal having a second, higher priority. A higher priority may be understood as an increased importance of the message. Although in NR a higher priority is associated with a decreasing priority class, the meaning is the same, i.e., in NR a decreased priority class may be understood as a more important signal to be transmitted and may have, thus, a higher priority.

According to an embodiment, the control unit 504 may randomly select, as at least a part of the evaluation parameter or set of evaluation parameters, a duration of the contention window used for evaluating the availability and/or a periodicity of evaluation windows associated with the contention window. The control unit 504 may select the duration and/or the periodicity between a minimum value and a maximum value. At least one of the minimum value and the maximum value may be associated with a transmission requirement parameter associated with the signal.

That is, the control unit may adapt the boundaries in which the random number is selected.

According to an embodiment, the device may be configured for further selecting a decreasing value of at least one of a minimum contention window duration and a maximum contention window duration based on a decreasing remaining packet delay budget associated with the signal.

According to an embodiment, as described in connection with FIG. 7, the device may map at least the signal, optionally additional signals to one or more channel access classes of the wireless communication network. A resource pool configuration of the wireless communication network may be used by the device for transmitting the signal, the resource pool configuration associated with the transmission requirement parameter of the signal and with the channel access class.

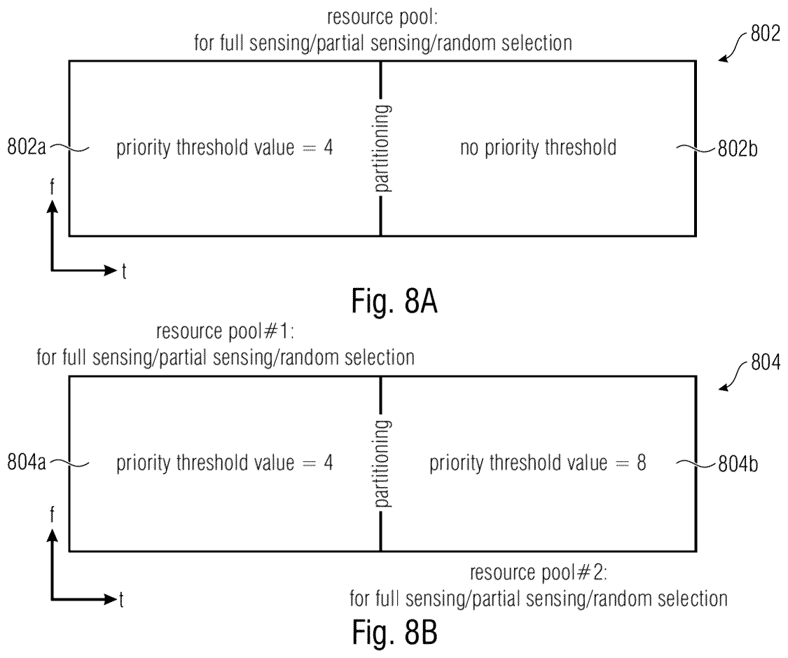

With regard to FIGS. 8A and 8B, the resource pool configuration may comprise different resource pools allowed or reserved for specific purposes. For example, as illustrated in FIG. 8A, a resource pool configuration 802 may be partitioned into two (or more) resource pools 802a and 802b from which a subset, e.g., resource pool 802a is restricted for a priority threshold value. A different partition of the resource pool and preferably disjointed resource pool 802b may be assessable without priority threshold or, as illustrated in FIG. 8B with a different priority threshold. The priority value of 4 is chosen as an example and indicates that high priority traffic with a priority class<5, may be transmitted in the partition 802a or 802b, while low priority traffic can only be transmitted in the partition 802b. Thus for higher priority transmission, resource can be chosen from a larger set of candidates, namely the whole resource pool.

As an alternative to resource pool partitioning as described in FIG. 8A, another approach to segregate priority per resource pool. As illustrated in FIG. 8B, different resource pools 804a and 804b of a resource pool configuration 804 may each be reserved for different priority threshold values. Thus, the full resource pool #1 is reserved for high priority transmissions, while resource pool #2 allows also lower priority transmissions, e.g., transmission with the priority 5, 6, 7, and 8.

While both concepts work, resource pool partitioning may allow better resource utilization since it allows all priority types in a given resource pool. Furthermore, the partitioning can be defined per resource pool configuration or preconfiguration or could be also adopted based on the current utilization of a resource pool, e.g., by signaling from a base station or another UE, e.g., group lead GL-UE or scheduling UE, or by and RSU.

The concepts of FIG. 8A and 8B may be combined with each other, for example, when providing for a resource pool configuration having more than two resource pools, some of them being associated with a priority threshold value that may differ between different resource pools and having at least one resource pool with no associated priority threshold.

The resource pool configuration 802 and/or 804 may comprise a so-called exceptional resource pool of the wireless communication network. Such an exceptional resource pool may be a resource pool without defining a specific purpose such as important or unimportant priorities. In other words, FIG. 8A describes a concept according with embodiments in which a set of resources of resource pool 802a is selected according to a priority threshold referring to resource partitioning. FIG. 8B describes to select a resource pool according to a priority class. Alternatively, e.g., for low priority data traffic or if other resource pools are congested, high/low priority traffic may be transmitted in the exceptional resource pool that is typically used for handovers. Beside the specific example referring to the priority, a device in accordance with embodiments may comprise control unit 504 configured for mapping different data streams to be transmitted and being associated with different transmission requirement parameters to different logical channels. Alternatively or in addition, the device may select different evaluation parameters for the different data streams based on the different transmission requirement parameters.

### Adaption of the CW Size

Some aspects described herein relate to a selection of an evaluation parameter such as a contention window setting. Some aspects described herein relate to an adaptation of a selected or initial evaluation parameter. For example, a contention window setting once selected may be adapted. Multiple reasons may lead to an adaption, a single reason on its own and/or in combination with other reasons. Possible reasons may be, for example, a change in a channel condition, e.g., reported as a channel condition information, CCI. An example parameter at least partly indicating the channel condition may relate to a channel quality, a channel occupancy, channel busy rate, a number of collisions or other measurements relating to a past, present or future condition.

Therefore, another aspect is the adaption of the evaluation parameter such as the size of the CW interval. In case of a congested channel, the intention is to increase the CW interval, while the CW interval shall be decreased for a mainly unused channels. In the following mechanisms based on which the CW size can be adapted are described. The number of NACKs can also be one of the criteria for the UE to consider, as it is done for NR-U (e.g., “Criteria 80% NACKs within a slot/COT”). Furthermore, one or more of the following criteria may also be considered:
A congestion status of the resource pool/band (band includes all RPs which are within the band)
   Determined based on sensing, and/or,
   Determined based on received AIMs
A number or ratio of collision indications (CI) that are received in a RP or band or subchannel or for a set of resources or a single resource, e.g., a conflict information such as a number or ratio of past and/or future collision indications (CI) that are received in a resource pool, in a band and/or for a transmission block, TB for the subchannel or for a set of resources or a single resource.

According to an embodiment, the control unit 504 may be configured for selecting the evaluation parameter for a transmission of the signal 506 and for adapting the evaluation parameter for a future transmission in the sidelink to transmit a new signal or to retransmit signal 506. The adaptation may be based on a channel condition of the sidelink. The adaptation may lead, on the one hand, to a changed or modified evaluation parameter or, on the other hand to a re-selection of the value or setting of the evaluation parameter which may be understood as a way of confirming the value or setting of the evaluation parameter.

According to an embodiment the control unit 504 may be configured for receiving channel condition information, CCI indicating the channel condition. Based on the CCI the control unit may update the evaluation parameter, e.g., based on a timing of the channel condition information and/or a number of channel condition information received and/or a time gap between a physical sidelink feedback channel, PSFCH and a sidelink control information.

The CI can be a detected past and/or detected potential future resource conflict. For example, resource conflicts can be indicated by another UE. This can be signaled via SCI (1^{st} and/or 2^{nd}-stage SCI). Other means of signaling are also possible, e.g., RRC, MAC-CE or higher layer signaling. Another possibility to signal an expected/potential resource conflict is to use signaling within the sidelink feedback channel, e.g., PSFCH, e.g., PSFCH format 0, which is indicated via SCI. A feedback may be a suitable way for signaling in case a prior transmission/communication already provides for a reason for feedbacking.

Conflicted resources can be reserved resources by a UE, which fully/partially overlap with resource indicated by another UE in time and/or frequency.

One further aspect is the timing of the CI as well as the number of CIs received by the said UE. In case the CI is received within a certain time window, the CW size could be updated. The timing may also depend on the time gap between the PSFCH and the SCI(s) scheduling a conflicting transmission block, TB. The received information may be used for determining statistics. Such statistics may be determined by any node in the wireless communication network aware of the underlying information, e.g., the control unit 504 or a different entity, the different entity providing the result of the statistics to the device 500. According to an embodiment, the control unit 504 may be configured for generating a statistical information from the channel condition information and for adapting the evaluation parameter based on the statistical information. According to an embodiment, the device 500 receives the statistics and uses the statistics for the adaptation, i.e., the statistics is generated outside the device 500. For example, he statistical information is based on
a threshold, e.g., based on HARQ feedback, e.g., a target error rate of 10% HARQ NACKS may be configured; e.g., if the threshold is exceeded, one or more evaluation parameters are adapted; and/or
data collected within a time window or sliding window or sliding window, e.g., exponential decaying weighting factor, e.g., the more recent data is weighted higher than older data using an exponential function.

The statistics may comprise a consideration of one or more of the following: time and/or temporal changes, frequencies, resource pools, local information such as areas and other relevant information. For example, the statistics may indicate a zonal area usage map, ZARUM, that may provide for usage statistics within zones. However, other evaluated parameters such as a channel busy rate, CBR, may alternatively or in addition provide for statistics.

In a further embodiment, in case the number of CIs per conflicted TB or in case the total number of CIs received is above a (pre-)configure threshold, the CW size could be adapted accordingly, e.g., if the total number of CIs exceeds a threshold, then the CE size in increased by a number of slots or transmission time intervals (TTIs). This can, in addition or as an alternative, also depend on the numerology used within the considered bandwidth part (BWP), e.g., higher numerology equals a larger subcarrier spacing (SCS) which results in picking larger values for the maximum content window in case a conflict is detected or will potentially occur. Alternatively or in addition the detection of a CI can also depend on the detected RSRP on a given resource. In accordance with this finding, an embodiment provides for a control unit 504 that may be configured for selecting, as the evaluation parameter, a first time duration of a contention window for a first channel condition, and for adapting the contention window to have a second, increased time duration for a second channel condition in which the channel is busier when compared to the first channel condition. This applies, without limitation vice versa, i.e., a more idle channel may lead to a shorter CW as the risk for a collision is reduced.

However, some important differences have to be considered for SL, as the UE may not have a sufficient number of packets to transmit within a slot/COT. Typically, a UE would have a single packet which would lead to an increase of the CW at each NACK which would harm the overall efficiency of the system. Therefore, the UE may consider a number of feedback messages, e.g., a number of ACKs or NACKs, for evaluating the adaption of the CW size based on one or more of the following criteria:
A slot or a time window where a feedback is transmitted, e.g., whether it is transmitted in the one or more reference slots/PSFCHs,
Reception of an SCI pointing to the said feedback, e.g., ignore feedback if SCI was not received,
Signal strength/proximity of SCI pointing to the feedback, e.g., ignore low-power feedback because probably the physical distance to the UE transmitting this feedback is large and this will not cause a potential future resource conflict,
Whether NACK is assumed because feedback is not received or an actual NACK was detected, e.g., a high number of received NACKs will increase the contention window (CW) to reduce the channel load and decrease the chance of future collisions. Feedback which is not received however does not necessarily indicate a NACK/collisions but can also happen when the receiver is unable to get channel access for transmitting the HARQ feedback. In this case, the contention window does not need to be increased in the same way.
Cast-type of the associated transmission, e.g., the CW might only be increased for unicast traffic, why it remains fixed for groupcast or broadcast traffic,
Destination UE/Source UE (e.g., of the future transmission or of a channel indicator indicating the channel condition):
   Consider feedback which is transmitted to the said UE,
   Consider feedback which is transmitted to a group which the UE belongs to
   Consider feedback which is transmitted by a certain UE, having a (pre-)configured ID, e.g., a coordinating UE or group lead UE (GL-UE) or scheduling UE or RSU. Note, that a scheduling UE is a UE that can assign or allocate a set of resources to another UE or inform a UE on a set of non-preferred resources, that another UE should avoid when picking resource by itself.
a pre-emption indication.

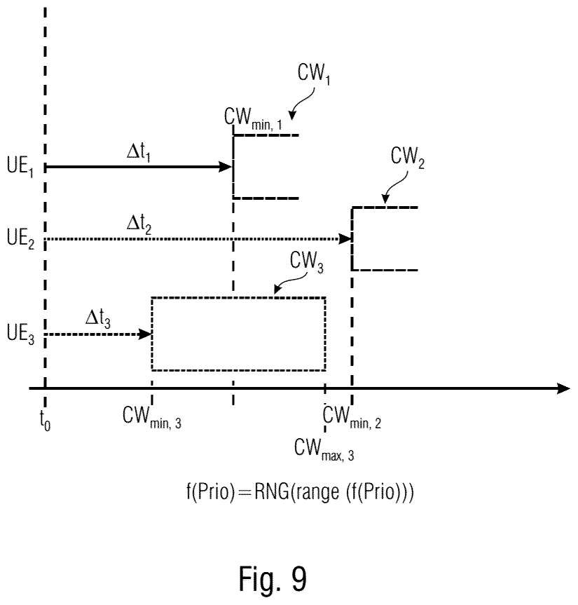

FIG. 9 shows a schematic time line for illustrating a competitive situation of UEs UE₁, UE₂ and UE₃ aiming for transmission. In the given example, the contention window as well as parameters CWₘᵢₙ and/or CWₘₐₓ values can be a function of several parameters, for example, a priority (PRIO) of the signal to be transmitted. A random number RN provided by a random number generator, RNG, may be within a range between CWₘᵢₙ and CWₘₐₓ as a function of the priority f(Prio). For example, UE₃ having a content with a higher priority when compared to signals of UE₂ and UE₁ may have a higher probability to be the first UE to transmit a signal 506₁.

The control unit 504 may be configured for selecting the evaluation parameter as a setting of the contention window used for evaluation and may be configured for selecting the evaluation parameter to comprise an offset in time prior to a start of the contention window. The offset in time Δt may also be a function of priority.

That is, the transmission requirement such as the priority or the packet delay budget or other parameters thereof may at least influence time delays or offsets in time Δt₁, Δt₂ and/or Δt₃ as well as at least one of the lower boundaries CW_{MIN}, upper boundaries CW_{MAX} or the time distance there between.

According to an embodiment, the control unit 504 may be configured for adapting, as the evaluation parameter, a start, and end and/or a size of a contention window, e.g., CW₁, CW₂ and/or CW₃ used for evaluation and, the size relating to a time duration of the contention window. The adaptation of the evaluation parameter may relate, in some embodiments, to adapting the evaluation parameter based on the channel condition for a same transmission requirement parameter of the future transmission when compared to the transmission of the signal. That is, at least one, some or all of the signal-related parameters may be same or comparable but due to a change in the signal condition, the control unit may adapt the evaluation parameter.

The adaptation may be based on a channel condition such as an occupancy of the sidelink channel or of a set of resources of the sidelink to be used for transmitting the signal 506. The control unit 504 may be configured for selecting a decreased time duration based on a low occupancy when compared to a time duration selected for a high occupancy of the sidelink channel or set of resources. The occupancy may be measured in different ways, for example, by use of CBR, RSRP, RSRQ, SINR, SNR and/or combinations thereof.

According to an embodiment, the channel condition of the sidelink relates at least in parts to at least one of:
a number of positive acknowledgments recognized in the sidelink,
a number of negative acknowledgements recognized in the sidelink,
a congestion status of a resource pool/band, e.g., determined based on sensing and/or based on a received message such as an assistance information message,
a conflict information such as a number or ratio of past and/or future collision indications (CI) that are received in a resource pool, in a band and/or in a transmission block, TB,
power measurement, interference power, CBR, RSRP, SNR, SINR etc. or other KPIs, e.g., measured on the DMRS symbols.

As an alternative or in combination, the device 500 may be configured for receiving, from another device in the wireless communication network, a conflict information or inter-UE coordination information message (IuC) indicating at least a part of the channel condition. Such conflict information may be received as a part of a sidelink control information, SCI, such as 1^{st} or 2^{nd}-stage SCI, a radio resource control, RRC or PC5-RRC, information, a medium access control-control element MAC-CE, a higher layer signaling and/or a signaling within the sidelink feedback channel (PSFCH).

The pre-emption indication above may be useful for a consideration of e.g., if the transmissions of the device 500 are often pre-empted, e.g., in view of statistics, the control unit may be configured for deriving, from the high number or high rate of pre-emptions, to adapt the evaluation parameter, e.g., contention window, such as shorter or longer, e.g., based on the priority.

### Idea 2: HARQ-Feedback Optimization for CW Adaptations

When referring to the feedback not received above, according to an embodiment, the control unit 504 may be configured for not increasing a time duration of a contention window used for evaluation in a case where a feedback which is not received, e.g., with respect to a receiving time window. This may be based on the finding that the feedback is not received based on a circumstance that is not sufficiently addressed by change of the evaluation parameter. Therefore, the control unit may maintain the evaluation parameter in case of an expected but missing feedback, optionally in connection with further considerations.

With regard to the maintaining of the evaluation parameter/contention window in a case a feedback is not received, a further finding of the inventors is related with the some of the embodiments described herein.

A missing feedback may have several reasons wherein the adaptation of the respective evaluation parameter or set of parameters may be beneficial or helpful for only a subset of reasons thereof. For example, a feedback may be missing at the receiving device 500 based on a bad channel condition, e.g., low SINR or interference, on the one hand and a collision on the other hand. Whilst the latter may provide for a reason to adapt the contention window, the adaptation of the contention window providing for a solution in case of a collision, such an adaptation may provide for low benefits in case of the earlier. Based on this finding, embodiments some embodiments in connection with the adaptation of the evaluation parameter are described. However, those aspects may also be implemented independently from the adaptation and provide in both cases for embodiments of the described hereinafter.

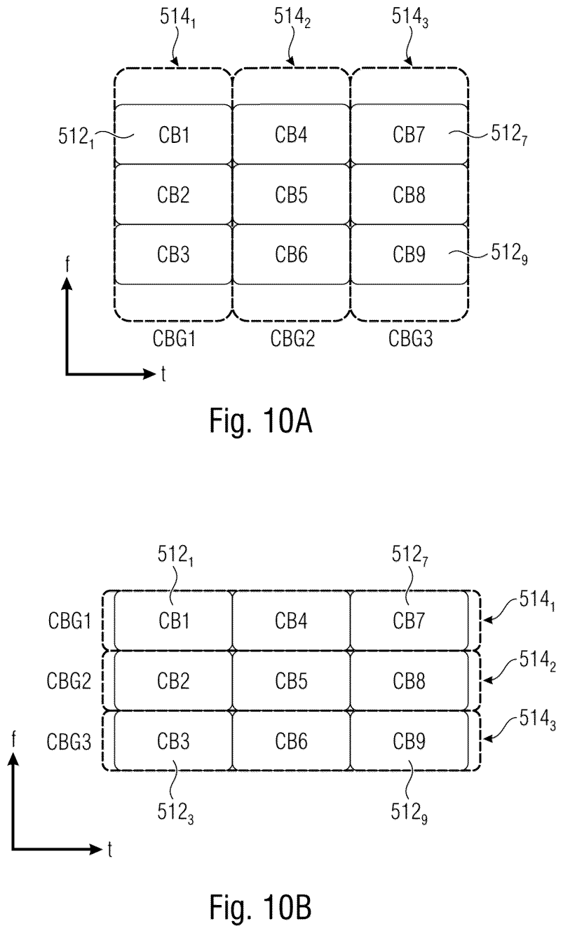

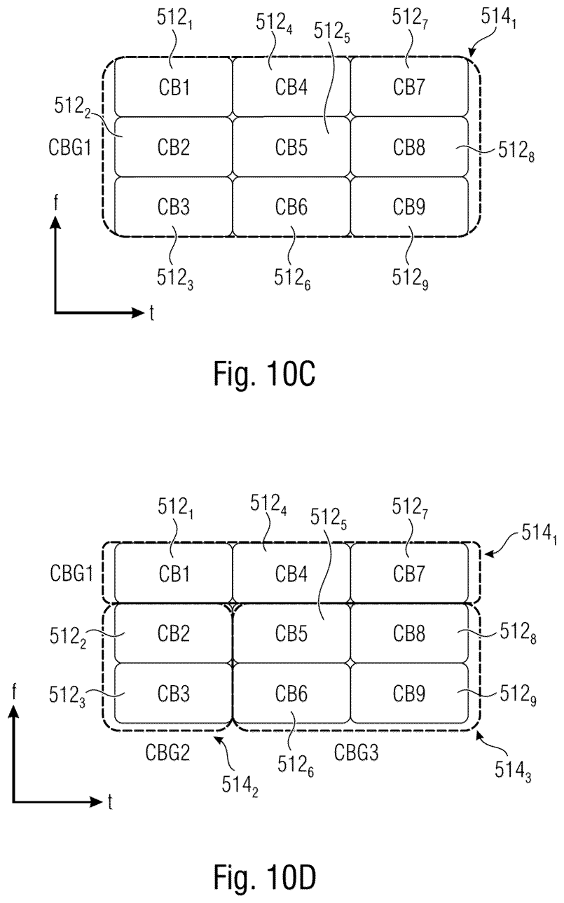

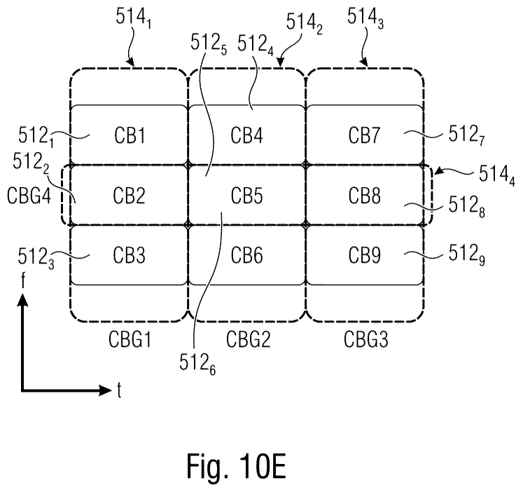

According to an embodiment, the control unit 504 may be configured for transmitting the signal as a plurality of part signals. A part signal may relate to a use of a code block, CB, i.e., a plurality of CBs is used for transmitting the signal as shown, for example, in FIGS. 10A-E. However, a part signal may also relate to grouping a number of transmission blocks, TBs, together.

By way of non-limiting example FIGS. 10A-E show each an arrangement of 9 code blocks CB1 shown as 512₁ to CB9 shown as 512₉ arranged in a non-limiting number of three lines and three columns according to a matrix arrangement, wherein neither the matrix structure nor the number of lines nor the number of lines limits the embodiments described herein.

The CBs 512₁ to 512₉ may be grouped into code block groups, CBG, 514₁ to 514₃, each CBG having a same or different number of code blocks 512. The grouping of the CBs into CBGs may be provided on a system side, e.g., as a network or cell configuration, e.g., provided by the eNB/gNB and/or may be decided statically or dynamically by UE 500, e.g., the control unit 504 thereof.

FIG. 10A shows an example configuration in which each column of the matrix arrangement forms a CBG 514₁ to 514₃.

FIG. 10B shows an example configuration in which each line of the matrix arrangement forms a CBG 514₁ to 514₃.

FIG. 10C shows an example configuration in the CBs 512₁ to 512₉ are part of a single CBG 514₁.

FIG. 10D shows an example configuration in which the CBs 512₁ to 512₉ are arbitrarily grouped, e.g., a line comprising CBs 512₁, 512₄ and 512₇ forming CBG 514₁, a part of a column comprising CBs 512₂ and 512₃ forming CBG 514₂ and/or parts of different lines and/or different columns comprising CBs 512₅, 512₆, 512₈ and 512₉ forming CBG 514₃.

FIG. 10E) shows an example configuration in which at least some CBs are members of more than a single CBG. Starting from, for example, the configuration according to FIG. 10A an additional CBG 514₄ is formed so as to comprise CBs 512₁, 512₅ and 512₈. Any other structure of CBs and/or any other grouping of CBs into CBGs in a way that at least one CBG is formed, each CBG comprising at least one CB and each CBG having a same or different number of CB and that every considered CB is a member of at least one CBG may form a basis for the following considerations. Each CB may be used for transmitting a part signal, wherein each transmitted part signal may allow for a reception of a feedback information, e.g., an ACK or a NACK.

In other words, a possible optimization at the UE is to put more than one transmission block, TB, per frequency and/or use code block groups (CBGs) to increase the probability of ACKs for an ongoing transmission. Also, for this, it could be possible to introduce a multi-stage NACK, per code block (CB) or per CBG. The adaptation of the CW, e.g., CW size and/or boundaries (CWₘᵢₙ and/or CWₘₐₓ), could then depend on the type or amount of feedback received. In one example, the CW does not have to be adjusted in case at least 1 ACK for a CBG is received. On the contrary, if the number of NACKs received per CBG exceeds a (pre-)configured threshold, this would yield in an adaptation of CW-values.

FIGS. 10A to 10E show how transport blocks can be split into code blocks (CBs) and code block groups (CBGs). CBGs can be aligned in the time/frequency/spatial domains accordingly. According to FIG. 10A and FIG. 10B a transport block contains several code blocks grouped into CBGs. CBGs can have different sizes, e.g., single CBG, or several CBGs containing a different number of CBs. FIG. 10C and FIG. 10D shows further examples of transport blocks separated into CBGs whilst FIG. 10E shows an example of overlapping CBGs, an overlapping mapping of CBs to CBGs allowing that one CB can be within more than one CBG.

Some embodiments provide for a control unit that considers feedback information for the overall CGB to determine a necessity to adapt the evaluation parameter. According to an embodiment, the control unit 504 may be configured for adapting the evaluation parameter based on a joint evaluation of plurality of feedback information received for the plurality of part signals, e.g. code blocks or code block groups.

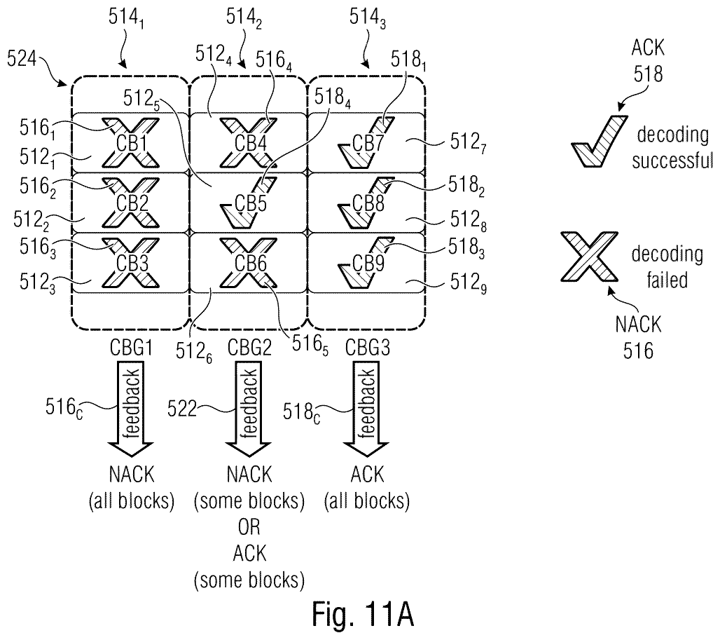

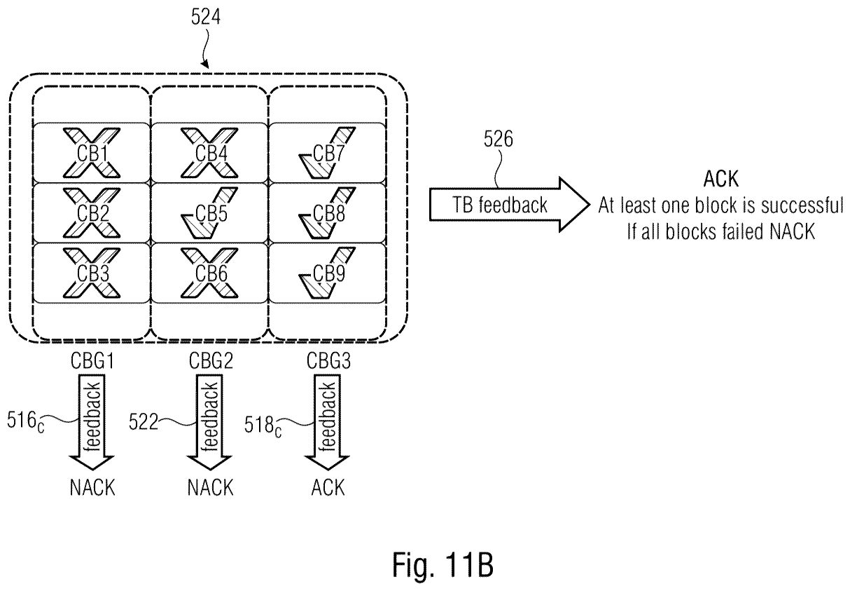

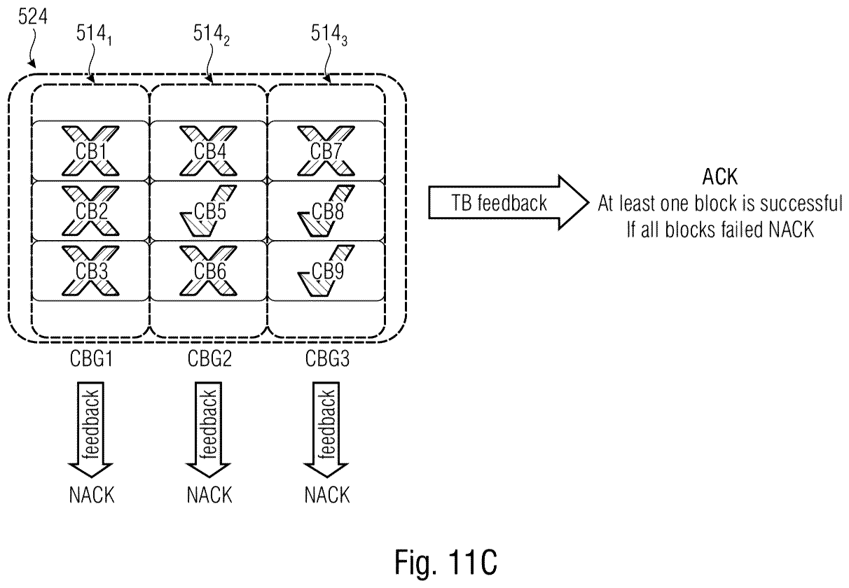

This is further explained in connection with FIGS. 11A to 11C. As shown in FIG. 11A part signals associated with CBs 512₁, 512₂ and 512₃ forming CBG 514₁ are unsuccessfully decoded which is reported with a respective NACK 516 which does not exclude a cumulative NACK 516_{C}. FIG. 11A shows a feedback including partial NACK/ACK if at least one block was successful. A transport block feedback may allow for a separate HARQ-reporting that can also be defined for CBGs and for TBs.

Further, whilst part signals associated with CBs 512₇, 512₈ and 512₉ forming CBG 514₃ are all successfully decoded which is reported with a respective ACK 518 which does not exclude a cumulative ACK 518_{C}.

However, for CBs 512₄, 512₅ and 512₆ forming CBG 514₂ an non-uniform result is obtained as signals in CBs 512₄ and 512₆ are decoded unsuccessful whilst CB 512₅ is successfully decoded. This allows for ACK 518₄ as well as NACKs 516₅ and 516₆ and/or a cumulative partial NACK partial ACK 522 respectively. Information 522 may have validity for a single CBG, a plurality of CBG and/or for the complete TB 524.

The control unit 504 may cause device 500 to transmit a partial (N)ACK 522 and/or may evaluate such information, either from partial (N)ACK or the combination of feedback 516₅, 516₆ and 518₄. Such information may provide for an indication that not a collision is the reason for unsuccessful decoding but possible the channel, i.e., that it is not necessary to adapt the evaluation parameter, e.g., the CW.

According to an embodiment, the control unit 504 may be configured for transmitting the signal 506 as a plurality of part signals, e.g., using one or more CBGs. The control unit 504 may be configured for adapting the evaluation parameter based on a joint evaluation of plurality of feedback information 516, 518, 522 received for the plurality of part signals.

With regard to CBG 514₂, a number of NACKs and/or a number of ACKs that is tolerable or required to decide the CBG as being incorrectly received or not received may be compared against a threshold value to allow for a respective decision.

The device may be configured for using for each part signal a transmission block, TB, and to group a plurality of TBs per frequency band; and/or for using, for each part signal, a code block of a code block group, CBG.

The control unit 504 may be configured for receiving first information indicating that at least a subset of the plurality of part signals was correctly received, e.g., as shown for CBG 514₂ and 514₃ and for maintaining at least one evaluation parameter, e.g., the contention window setting for the future transmission based on the first information. Alternatively or in addition, the control unit may be configured for receiving second information indicating that at least a number of the plurality of part signals exceeding a predefined threshold was incorrectly received or not received and for adapting one or more evaluation parameters for the future transmission based on the second information. Alternatively or in addition, the control unit may be configured for receiving, a partial acknowledgement as for only a subset of the plurality of part signals a positive acknowledgement, ACK, and/or for receiving, for only a subset of the plurality of part signals a negative acknowledgement, NACK, and for maintaining the evaluation parameter based on the partial acknowledgement.

In other words, a UE could report partial HARQ-feedback, in case it received some part of a TB or several CBs per CBG successfully/not-successfully. Both partial-ACK or partial-NACK feedback are possible. In the case of partial-ACK/NACK, data is received that cannot be decoded, nevertheless in some of the cases, the CW windows size and/or CWmin and/or CWmax does not have to be updated, if the number of errors is below a (pre-)configured threshold. Therefore, when supporting this, there basically exist three separate cases:
ACK: all data received can be decoded,
Partial ACK/NACK: some of the data contains errors, the data has to be retransmitted, but the contention window parameters remain the same,
NACK: data has to be retransmitted and contention windows parameters have to be updated.
   Alternatively, the update of the contention windows parameters can be handled in separate signaling. The UE can indicate, e.g., by using a flag, that the transmitting UE has to update its contention window parameters. The parameters in this case can be the length of the CW and/or the CWmin and/or CWmax parameters.

FIG. 11B shows a schematic representation of the CBs of FIG. 11A in which part results 516_{C}, 518_{C} and 522 lead to an overall ACK 526 indicating that at least one block is successful decoded. In case the number of successful decodes falls under a predetermined threshold and/or if the number of unsuccessful decodes rises to at least or above a predefined threshold, an overall NACK might be transmitted instead of overall ACK 526 being valid for TB 524.

This is highlighted in connection with FIG. 11C where all of the CBGs 514₁ to 514₃ comprise at least one CB that is unsuccessfully decoded, leading to partial (N)ACKs 522₁ and 522₂ for CBGs 514₂ and 514₃. However, based on at least one CB being successfully decoded or the number of 3 successfully decoded CBs being at least a threshold (vice versa the number of six unsuccessfully decoded CBs not exceeding a respective threshold) allows for overall ACK 526 in view of the adaptation of the evaluation parameter. ACK 526 may be interpreted by the control unit 504 to maintain the evaluation parameter.

### Idea 3: COT Sharing Between UEs

Another finding of the present invention is related to a second aspect in which the channel occupancy time, COT, is shared amongst devices. This finding and the technical features thereof may be implemented from the embodiments of the first aspect, but may be combined with each other, without any limitation.

That is, the device 500 may be configured for sharing a granted COT with another device of the wireless communication network as an alternative or in combination with adopting the evaluation parameter.

With regard to an implementation of the COT sharing as an independent aspect, the wireless communication network may provide for rules and/or procedures on how to allow a device to use the COT of another device. For example, the device may be configured for receiving COT information indicating the COT. The control unit 504 may be configured for evaluating the COT information and for determining that the COT is granted to the device. The device may be configured for partly using the COT for an own transmission in a first time portion of the COT. The control unit 504 may be configured to determine a second time portion based on a remaining time of the COT, the second time portion being a subset or all of the remaining time. The device is configured for transmitting a sharing signal comprising information indicating the second portion. For example, the device may indicate that its transmission has ended and that the remaining COT is free for other devices. As an alternative or in combination, the device may indicate a specific UE that is allowed or requested to use the remaining COT. Said other devices may itself use some or all of the allowed time and may pass over possibly remaining time to a third device or back to the device from which it has obtained the COT. According to some embodiments, the device is configured for reporting, e.g., may including into the sharing signal, a remaining COT timer indicating the remaining time.

The sharing signal may be transmitted or transported in a plurality of ways that may be defined in a fixed or adaptive way. For example, the sharing signal may be transmitted via one or more off:
a unicast,
a groupcast, and
a broadcast.

According to embodiments, the control unit 504 may be configured for generating the sharing signal so as to comprise an information associated with one or more favored devices, such as instructed, possible or suggested destination UEs, with which the COT is shared. This allows, e.g., via unicast or via groupcast to share the COT. In the example of a groupcast, if only one UE of the group wants to transmit, then it may occupy or grab the COT. Alternatively or in addition, a group lead (GL) UE may organize the use of the COT, e.g., among group members.

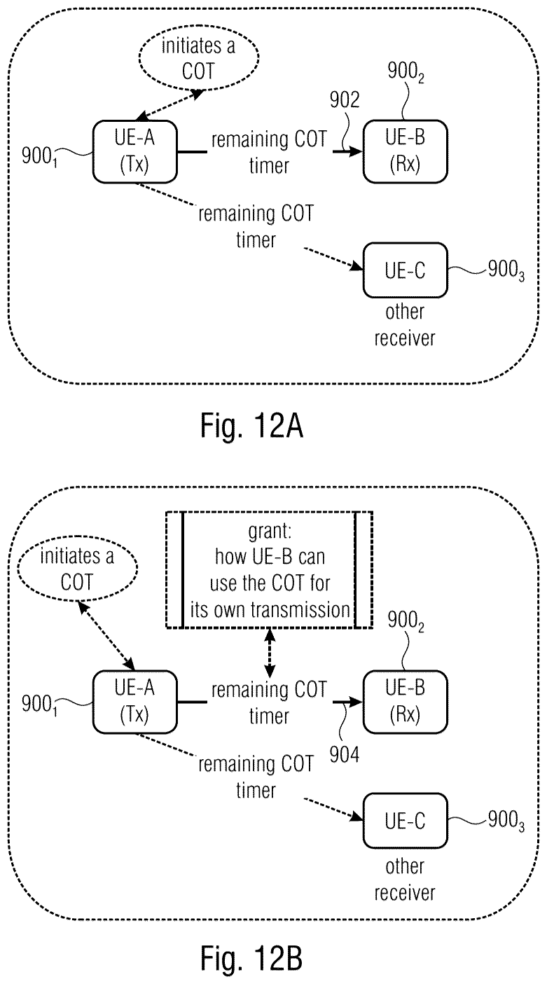

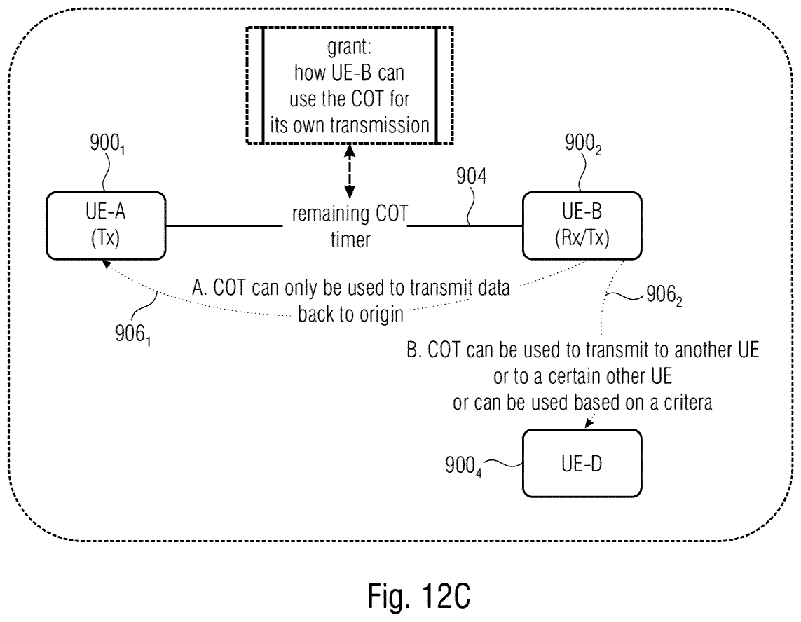

FIG. 12A shows a schematic block diagram illustrating a cooperation of three UEs 900₁, 900₂ and 900₃ according to an embodiment of the second aspect. Without limitation, the device 500 may operate in accordance with the second aspect and/or a device 900 may operate in accordance with the first aspect.

UE 900₁ marked as UE-A initiates a COT, i.e., it occupies or reserves the corresponding resources. Optionally, the UE 900₁ executes a transmission, wherein said transmission is not obligatory. By use of a sharing signal 902, UE 900₁ informs other UEs 900₂ and/or 900₃ about a remaining COT, e.g., by transmitting a remaining COT timer. UE 900₂ evaluating the sharing signal 902 may use at least a part of the remaining COT for an own transmission. This is also possible for UE 900₃, wherein UEs 900₂ and 900₃ may use the remaining COT concurrently, based on a priority list and/or based on an indication from UE 900₁ or a different node.

Such a scenario is illustrated in FIG. 12B where UE 900₁ informs, together with the remaining COT timer and by use of a sharing signal 904 that it passes over at least a part of the remaining COT to UE 900₂. The sharing signal 904 may comprise an information about a grant, to UE 900₂, how said UE can use the COT for its own transmission. This may allow to avoid collisions between UEs 900₂ and 900₃.

FIG. 12C shows a schematic block diagram of UEs 900₁, 900₂ and 900₄ using the sharing signal 904 by which UE 900₁ passes over at least a part of the remaining COT to UE 900₂. Based on a network implementation and/or a specific control that may be contained, for example, in the sharing signal 900₄, UE 900₂ may be allowed to transmit data, e.g., exclusively, back to UE 900₁ by use of a signal 906₁. Alternatively or in addition, UE 900₂ may be allowed to transmit a signal 906₂ to another UE such as UE 900₄. That is, the COT can be used to transmit data between the sharing UE 900₁ and a partner selected by this UE, e.g., using signal 906₁. Alternatively or in addition, the COT can be used by UE 900₂ to transmit signal 906 to another UE or a certain other UE or can be used based on a criteria.

The sharing of the COT may be used, for example, to use COT that would be unused, for example, by a device that has finished its transmission. Alternatively or in addition, a device such as a group leading device may control the COT and may pass over at least a part of a remaining COT to other devices for transmission. By sharing the COT, the device that receives at least a part of such COT by use of sharing, may avoid mechanisms such as LBT which may, thus, allow for a high network throughput.

### Addressed Problem

In NR-U, it is possible for a UE to carry out LBT and activate COT in case a UE detects that the channel is available. In NR-U, it can also share the COT among other UEs, which was fairly straightforward since it was controlled by the gNB. However, in mode 2 for SL, this is a bit challenging. Note, also for mode 1 UEs, COT sharing can be applied. In this case the gNB or an RSU can share COTs among UEs transmitting data via sidelink.

### Solution

If a UE such as device 900₁, which might be a group leading, GL, UE or a coordinating UE or an RSU, occupies the channel for the COT, it can share the COT with other UEs using one of the following methods:

### Solution 1: Using a New Parameter “Remaining COT Timer” in the SCI

In this case, UE₁ will occupy the channel for its own transmission, and when it transmits the first stage SCI (or within the second stage SCI), the SCI will include the new parameter called “Remaining COT Timer” which will indicate the remaining time left on the COT. This will inform other UEs that decode the SCI about the time left in the COT for its own transmissions and can accordingly use the channel.

Here, in the sensing and resource selection process, the UE will have to consider one more exclusion condition, where the UE can use a given resource only if it is within the COT, based on the remaining COT timer from other decoded SCIs.

What a UE receiving the “Remaining COT Timer” does:

A second UE which is communicating with the UE sending the SCI, e.g., destination UE indicated in the said SCI:
The UE can share the COT with the other UE.
Prepare data
   Any data
   Data meant for the UE from which the first SCI was received

A third UE such as device 900₃:
Considers the channel occupied for the remaining COT time

### Solution 2: Using AIMs

In this case, UE₁ (900₁) will use the channel for its own transmission, and then send an AIM to the neighboring UEs, e.g., via SL, in order to inform them about the COT and the remaining time left. This is particularly useful for groupcast communications, where the UE is a GL UE. It can then manage the usage of the COT among the group members by assigning sections of the COT to each of the members. Note, this notification on the COT can also be piggybacked with other data, feedback, control or broadcast information, that UE₁ has to transmit.

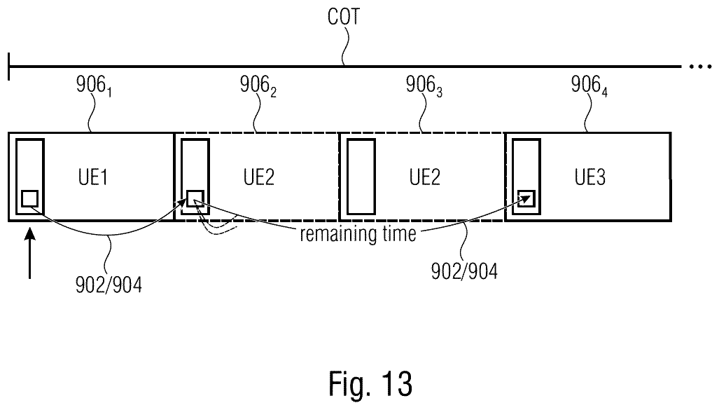

FIG. 13 shows a schematic diagram illustrating a COT distribution among UEs by another UE. UE₁, e.g., device 900₁ of FIG. 12A may initiate the COT. Using sharing signal 900₂ or 900₄, it may indicate a remaining COT, e.g., using an AIM or an SCI. UE₂, e.g., device 900₂, may derive, from the COT indicated in the sharing signal, a remaining time and an end of transmission of signal 906₁ and may, possibly, without significant delay, start its own transmission. Knowing the end thereof, it may indicate a remaining time in another sharing signal 900₂/900₄ such that UE₃, e.g., device 900₃ or 900₄ may perform another transmission in the same COT.

According to an embodiment, the device may be configured for transmitting the sharing signal 902 or 904 as a sidelink control information, SCI, e.g., within 1^{st} or 2^{nd} stage SCI or using the sidelink, e.g., PSCCH, e.g., by transmitting an assistance information message, AIM via PSFCH or by transmitting this information via the sidelink data channel, PSSCH, e.g., via a MAC or PC5-RRC message.

According to an embodiment, the device may be configured for using the sidelink; wherein the device is a group leading device of a group of devices in the wireless communication network; wherein the control unit is configured for distributing COT between other members of the group of devices.

According to an embodiment, the device is configured for receiving information indicating a remaining portion of the granted COT and for using the remaining portion for an own transmission. This can also be a group lead device or a kind of special sidelink device such as a road side unit (RSU).

According to an embodiment, the device may comprise a control unit, e.g., control unit 504 or a different control unit, configured for evaluating the remaining portion of the COT and a requirement of the own transmission wherein the device is configured for using the remaining portion only if the requirement fits the remaining portion. For example, the transmission is only started, if the COT provides for sufficient resources. Alternatively or in addition, the device may be configured for using the remaining portion together with additional available resources if the requirement does not fit the remaining portion. That is, in case the resources are of insufficient amount or quality, the device may add additional available resources. If the remaining portion is not enough, the device can, for example, add an own set of resource that were sensed by the device itself.

According to an embodiment, the device may be configured for receiving information indicating a plurality of remaining portions of a plurality of COT and for selecting a subset of the plurality of remaining portions for an own transmission. For example, a merging of this can be done on the PHY layer or on the MAC layer. The device may add additional resources if the remaining COT is not long enough, e.g., generated by sensing.

According to an embodiment, the device may comprise a control unit configured for evaluating at least one of a time duration of the plurality of remaining portions, a start time of the plurality of remaining portions and resources associated with the plurality of remaining portions with regard to a transmission requirement parameter of the own transmission to obtain an evaluation result; and for selecting the subset based on the evaluation result. For example, the selected subset may be the earliest suitable subset, a subset providing for sufficient time, for sufficient or suitable resources or the like. Such a merging can be done on the PHY layer, and/or on the MAC layer.

According to an embodiment, the COT is a first COT, wherein the device is configured for receiving information indicating a remaining COT of a second granted COT; wherein a control unit of the device is configured for considering resources associated with the second COT as being used or reserved based on the received information, i.e., the third UE may consider the channel as occupied for the remaining COT timer that is possibly indicated in the sharing signal.

According to an embodiment, the device may be configured for receiving a configuration signal with the antenna unit. A control unit of the device such as control unit 504 or a different control unit may be configured for evaluating the configuration signal with regard to a configuration information indicating whether sharing of granted COT is activated or deactivated. The device may be configured for sharing the COT only if the configuration information indicates that sharing of granted COT is activated. For example: an indication for current COT can be done in the SCI via a flag or by setting the remaining COT timer to 0. This can be beneficial in mode 1, if the gNB or a coordinating UE or RSU does not want a UE to grab the COT. Another possibility is to set the ‘favored UE’ to a pre-defined invalid value.

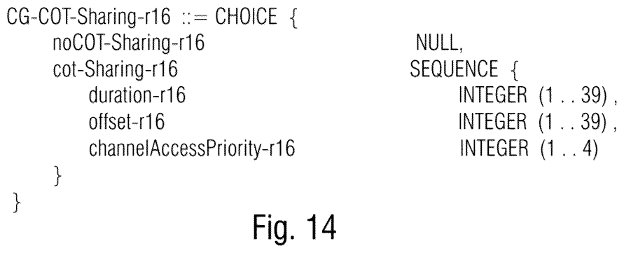

Such a possibility of a content of a configuration signal is shown in the example pseudo-code of FIG. 14 showing instructions that may be transmitted to a device, e.g., individually or via groupcast or broadcast to instruct, activate or deactivate the COT sharing according to the second aspect.

### COT Configurations

Currently the COT configuration is provided by the gNB using RRC information elements for configured grants.

The duration and offset to be used by a UE when sharing COT is already linked to priority.

Mode 1: However, in the COT configuration shown in FIG. 14, this does not provide the UE with any information regarding the number of TBs that it can transmit per COT, and the number of retransmissions of each TB that are possible per COT.

Mode 2: In Mode 2, a similar COT sharing configuration may be used.

The COT sharing configuration and whether COT sharing is allowed in a RP at all may be (pre-)configured to the UE within the RP configuration. It may also be enabled or disabled by a base station or RSU, depending on the utilization of a resource pool. Associated SCI signalling, such as the “remaining COT time” in the SCI, may only be present if COT sharing is allowed.

According to an embodiment, the device is configured for receiving the configuration signal with respect to a COT sharing configuration, as at least one of:
an indication, e.g., per resource pool, or per UE via PHY (1^{st} or 2^{nd}-stage SCI), MAC or RRC/PC5-RRC,
a configuration,
a preconfiguration.

According to an embodiment, the configuration signal is a sidelink control information, SCI, signal, e.g., 1^{st} or 2^{nd} stage SCI via PSCCH, or RRC or PC5-RRC or MAC or higher layer signaling.

According to an embodiment, the device may be configured for evaluating the configuration signal for resource pool configuration to obtain the configuration information.

For example, the configuration information may further indicates at least one of:
a maximum COT sharing duration, e.g., in ms or number of slots
time per device or sum of all devices transmissions within a COT.
a maximum number of devices that are allowed to share a COT.
a maximum of COT switches, e.g., a COT can only be shared or passed-on n-times
a COT can only be passed on to a UE that is within a certain range of the UE, e.g., minimum required communication range or zone of the said UE, e.g. geolocation
whether a physical sidelink feedback channel, PSFCH, initiates its own COT or whether it can share the COT with the previous slot;
   in case it shares with the previous slot, the device may ensure that the previous slot was used, e.g., depending on what was send in the previous transmission, e.g., data and/or control and/or feedback and/or CI.

### Shared COT Usage

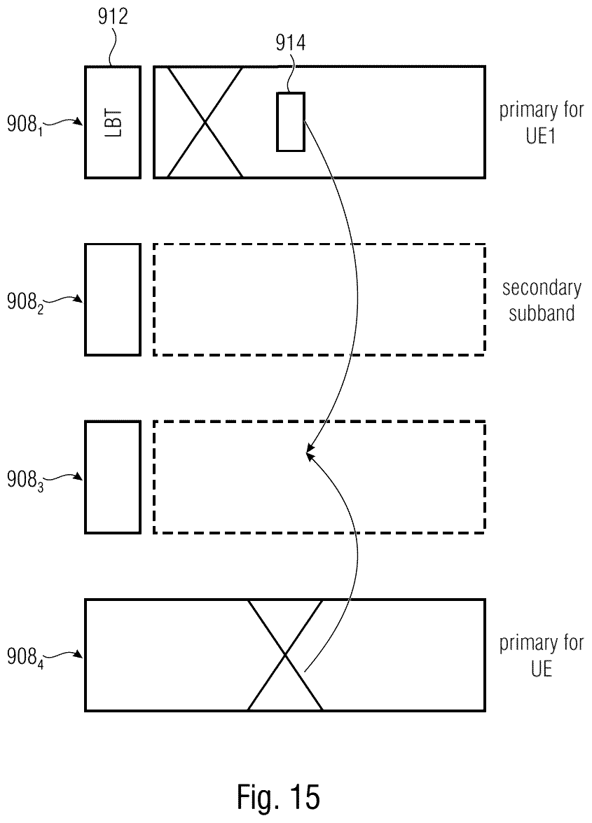

Besides passing over a remaining COT from one device to another, remaining COT may be provided to a device according to an overprovisioning, e.g., by receiving a remaining COT from multiple devices. That is, a device may get a grant for more than one subband and can choose which one it takes for its transmission as shown in FIG. 15. For example, four subbands 908₁ to 908₄ are shown. On subband 908₁ a first device performs LBT 912, e.g., in a known manner or in accordance with the first aspect, to obtain a COT for subband 908₁ as a primary subband and for subband 908₂ as a secondary subband. Similarly, a second device obtains a COT for subband 908₄ as a primary subband and for 908₃ as a secondary subband. COT for each of the secondary subbands may be shared as being unused by the first and second device allowing a third device to select from the subbands 908₂ and 908₃. Such an overprovisioning may also be indicated for a future transmission allowing to select at the time of the future transmission.

In case a UE receives more COTs then required, e.g., for several subbands as depicted in FIG. 15, the UE could choose which COT it would take. This can depend on the size of the COT, e.g., the size and/or location of the subband in time/frequency domain, and the size of the TB to be transmitted by the UE.

A shared COT according to embodiments may be used to transmit one or more of:
data,
control,
feedback, e.g., HARQ feedback, CSI feedback,
Inter-UE coordination messages (IUC), e.g., AIMs.

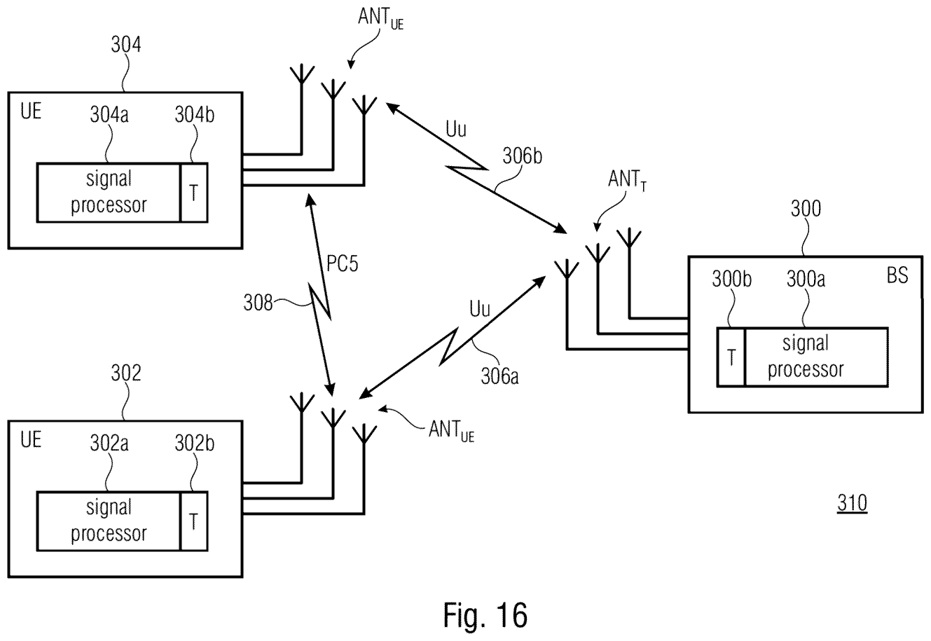

Embodiments of the present invention provide enhancements or improvements of the power saving possibilities or capabilities of a UE communicating over the sidelink and operating in a discontinuous reception, DRX, mode. Embodiments of the present invention may be implemented in a wireless communication system as depicted in FIG. 1, FIG. 2 or FIG. 3 including base stations and users, like mobile terminals or IoT devices. FIG. 16 is a schematic representation of a wireless communication system including a transmitter 300, like a base station, and one or more receivers 302, 304, like user devices, UEs. The transmitter 300 and the receivers 302, 304 may communicate via one or more wireless communication links or channels 306a, 306b, 308, like a radio link. The transmitter 300 may include one or more antennas ANT_{T} or an antenna array having a plurality of antenna elements, a signal processor 300a and a transceiver 300b, coupled with each other. The receivers 302, 304 include one or more antennas ANT_{UE} or an antenna array having a plurality of antennas, a signal processor 302a, 304a, and a transceiver 302b, 304b coupled with each other. The base station 300 and the UEs 302, 304 may communicate via respective first wireless communication links 306a and 306b, like a radio link using the Uu interface, while the UEs 302, 304 may communicate with each other via a second wireless communication link 308, like a radio link using the PC5 or sidelink, SL, interface. When the UEs are not served by the base station or are not connected to the base station, for example, they are not in an RRC connected state, or, more generally, when no SL resource allocation configuration or assistance is provided by a base station, the UEs may communicate with each other over the sidelink. The system or network of FIG. 16, the one or more UEs 302, 304 of FIG. 16, and the base station 300 of FIG. 16 may operate in accordance with the inventive teachings described herein.

### COMPUTER PROGRAM PRODUCT

Embodiments of the present invention provide a computer program product comprising instructions which, when the program is executed by a computer, causes the computer to carry out one or more methods in accordance with the present invention.

### General

Embodiments of the present invention have been described in detail above, and the respective embodiments and aspects may be implemented individually or two or more of the embodiments or aspects may be implemented in combination.

In accordance with embodiments, the wireless communication system may include a terrestrial network, or a non-terrestrial network, or networks or segments of networks using as a receiver an airborne vehicle or a spaceborne vehicle, or a combination thereof.

In accordance with embodiments, the user device, UE, described herein may be one or more of a power-limited UE, or a hand-held UE, like a UE used by a pedestrian, and referred to as a Vulnerable Road User, VRU, or a Pedestrian UE, P-UE, or an on-body or hand-held UE used by public safety personnel and first responders, and referred to as Public safety UE, PS-UE, or an IoT UE, e.g., a sensor, an actuator or a UE provided in a campus network to carry out repetitive tasks and requiring input from a gateway node at periodic intervals, or a mobile terminal, or a stationary terminal, or a cellular IoT-UE, or a vehicular UE, or a vehicular group leader, GL, UE, a scheduling UE (S-UE) or coordinating UE, or an IoT, or a narrowband IoT, NB-IoT, device, or a WiFi non Access Point STAtion, non-AP STA, e.g., 802.11ax or 802.11be, or a ground based vehicle, or an aerial vehicle, or a drone, or a moving base station, or a road side unit, or a building, or any other item or device provided with network connectivity enabling the item/device to communicate using the wireless communication network, e.g., a sensor or actuator, or any other item or device provided with network connectivity enabling the item/device to communicate using a sidelink the wireless communication network, e.g., a sensor or actuator, or any sidelink capable network entity.

The base station, BS, described herein may be implemented as mobile or immobile base station and may be one or more of a macro cell base station, or a small cell base station, or a central unit of a base station, or a distributed unit of a base station, or an Integrated Access and Backhaul, IAB, node, or a road side unit, or a UE, or a group leader, GL, or a relay, or a remote radio head, or an AMF, or an SMF, or a core network entity, or mobile edge computing entity, or a network slice as in the NR or 5G core context, or a WiFi AP STA, e.g., 802.11ax or 802.11be, or any transmission/reception point, TRP, enabling an item or a device to communicate using the wireless communication network, the item or device being provided with network connectivity to communicate using the wireless communication network.

Although some aspects of the described concept have been described in the context of an apparatus, it is clear that these aspects also represent a description of the corresponding method, where a block or a device corresponds to a method step or a feature of a method step. Analogously, aspects described in the context of a method step also represent a description of a corresponding block or item or feature of a corresponding apparatus.

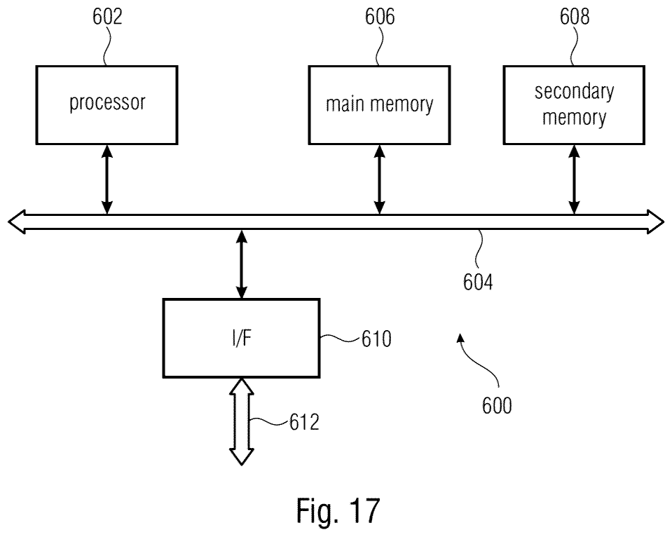

Various elements and features of the present invention may be implemented in hardware using analog and/or digital circuits, in software, through the execution of instructions by one or more general purpose or special-purpose processors, or as a combination of hardware and software. For example, embodiments of the present invention may be implemented in the environment of a computer system or another processing system. FIG. 17 illustrates an example of a computer system 600. The units or modules as well as the steps of the methods performed by these units may execute on one or more computer systems 600. The computer system 600 includes one or more processors 602, like a special purpose or a general-purpose digital signal processor. The processor 602 is connected to a communication infrastructure 604, like a bus or a network. The computer system 600 includes a main memory 606, e.g., a random-access memory, RAM, and a secondary memory 608, e.g., a hard disk drive and/or a removable storage drive. The secondary memory 608 may allow computer programs or other instructions to be loaded into the computer system 600. The computer system 600 may further include a communications interface 610 to allow software and data to be transferred between computer system 600 and external devices. The communication may be in the from electronic, electromagnetic, optical, or other signals capable of being handled by a communications interface. The communication may use a wire or a cable, fiber optics, a phone line, a cellular phone link, an RF link and other communications channels 612.

The terms “computer program medium” and “computer readable medium” are used to generally refer to tangible storage media such as removable storage units or a hard disk installed in a hard disk drive. These computer program products are means for providing software to the computer system 600. The computer programs, also referred to as computer control logic, are stored in main memory 606 and/or secondary memory 608. Computer programs may also be received via the communications interface 610. The computer program, when executed, enables the computer system 600 to implement the present invention. In particular, the computer program, when executed, enables processor 602 to implement the processes of the present invention, such as any of the methods described herein. Accordingly, such a computer program may represent a controller of the computer system 600. Where the disclosure is implemented using software, the software may be stored in a computer program product and loaded into computer system 600 using a removable storage drive, an interface, like communications interface 610.

The implementation in hardware or in software may be performed using a digital storage medium, for example cloud storage, a floppy disk, a DVD, a Blue-Ray, a CD, a ROM, a PROM, an EPROM, an EEPROM or a FLASH memory, having electronically readable control signals stored thereon, which cooperate or are capable of cooperating with a programmable computer system such that the respective method is performed. Therefore, the digital storage medium may be computer readable.

Some embodiments according to the invention comprise a data carrier having electronically readable control signals, which are capable of cooperating with a programmable computer system, such that one of the methods described herein is performed.

Generally, embodiments of the present invention may be implemented as a computer program product with a program code, the program code being operative for performing one of the methods when the computer program product runs on a computer. The program code may for example be stored on a machine readable carrier.

Other embodiments comprise the computer program for performing one of the methods described herein, stored on a machine readable carrier. In other words, an embodiment of the inventive method is, therefore, a computer program having a program code for performing one of the methods described herein, when the computer program runs on a computer.

A further embodiment of the inventive methods is, therefore, a data carrier, or a digital storage medium, or a computer-readable medium comprising, recorded thereon, the computer program for performing one of the methods described herein. A further embodiment of the inventive method is, therefore, a data stream or a sequence of signals representing the computer program for performing one of the methods described herein. The data stream or the sequence of signals may for example be configured to be transferred via a data communication connection, for example via the Internet. A further embodiment comprises a processing means, for example a computer, or a programmable logic device, configured to or adapted to perform one of the methods described herein. A further embodiment comprises a computer having installed thereon the computer program for performing one of the methods described herein.

In some embodiments, a programmable logic device, for example a field programmable gate array, may be used to perform some or all of the functionalities of the methods described herein. In some embodiments, a field programmable gate array may cooperate with a microprocessor in order to perform one of the methods described herein. Generally, the methods are preferably performed by any hardware apparatus.

While this invention has been described in terms of several embodiments, there are alterations, permutations, and equivalents which fall within the scope of this invention. It should also be noted that there are many alternative ways of implementing the methods and compositions of the present invention. It is therefore intended that the following appended claims be interpreted as including all such alterations, permutations and equivalents as fall within the true spirit and scope of the present invention.

1. A device configured for wirelessly transmitting a signal via a sidelink of a wireless communication network, e.g., 5G New Radio, the device comprising:
a control unit configured for evaluating an availability of resources of the sidelink using an evaluation parameter,
wherein the control unit is configured to adapt the evaluation parameter.

2. The device of claim 1, wherein the sidelink of the device is associated with a frequency band, e.g., ISM band, wherein the device is to perform a listen before talk (LBT) procedure before transmitting (spec: e.g., according to ETSI BRAN regulation) in the frequency band.

3. The device according to claim 1, wherein the evaluation parameter relates to at least one of the following:
a contention time of a contention window, the contention window used for monitoring the resources, the contention window comprising a contention window setting,
monitoring the resources during at least one evaluation window of the contention window, the evaluation parameter relating to
a start time and/or a length of the evaluation window,
an evaluation periodicity, e.g., a number and/or distribution of at least one evaluation window in the contention window,
at least one evaluation window being contiguous or non-contiguous in the contention window.
a power threshold, e.g., based on a channel busy ratio (CBR) or SNR, or comprising information on the interference, e.g., using RSRP, RSRQ, SINR, interference power,
a detection of a preamble, e.g., preamble of a WiFi system, or demodulation reference signals (DMRS) transmitted from another device (NR, LTE).

4. The device according to claim 1, wherein the control unit is configured for selecting the evaluation parameter, e.g., a contention window setting, from one of a plurality of candidates, the selected candidate comprising the evaluation parameter.

5. The device according to claim 1, wherein the device is configured to select resources for transmission based on the evaluation.

6. The device of claim 1, wherein the control unit is configured for selecting the evaluation parameter based on a transmission requirement parameter associated with the signal.

7. The device of claim 1, wherein the control unit is configured for selecting the evaluation parameters or priority class based on at least one of the following transmission requirement parameters:
a priority of a packet (control/data/feedback) or the signal to be transmitted;
a packet delay budget of the packet or the signal;
an unsuccessful prior attempt to transmit the packet or the signal;
a detected collision during a prior transmission;
a conflict in a future transmission
a received assistance information message, AIM.
a cast type of the packet
a zone ID or geolocation or minimum required communication range (MCR)
a transmission type.

8. The device of claim 7, wherein the transmission type relates to at least one of:
a data transmission
a control transmission
a feedback transmission such as a HARQ information or collision indicator (CI) information;
an inter-UE coordination (IuC) information message transmission; and
a synchronization signal transmission.

9. The device of claim 7, wherein the control unit is configured for selecting the evaluation parameter to select a time duration of a contention window used for evaluating the availability based on the priority class.

10. The device of claim 9, wherein the control unit is configured for selecting a first time duration for a first signal comprising a first priority; and for selecting a second, shorter time duration for a second signal comprising a second, higher priority.

11. The device of claim 1, wherein the control unit is configured randomly selecting, as at least a part of the evaluation parameter, a duration of a contention window used for evaluating the availability and/or a periodicity of evaluation windows associated with the contention window and for selecting the duration and/or the periodicity between a minimum value and a maximum value, wherein at least one of the minimum value and the maximum value is associated with a transmission requirement parameter associated with the signal.

12. The device of claim 1, wherein the control unit is configured for adapting one or more evaluation parameters based on an occupancy of the sidelink channel or based on the occupancy of a set of resources of the sidelink to be used for transmitting the signal.

13. The device of claim 1, wherein the control unit is configured for selecting a decreased time duration of the contention window based on a low occupancy when compared to a time duration selected for a high occupancy of the sidelink channel or set of resources.

14. The device of claim 1, wherein the control unit is configured for selecting the evaluation parameter for a transmission of the signal and for adapting the evaluation parameter for a future transmission in the sidelink based on a channel condition of the sidelink.

15. The device of claim 14, wherein the adapting relates to an adaptation of at least one of a start, an end and a duration of a contention window used for evaluation.

16. The device of claim 14, wherein the channel condition of the sidelink relates to at least one of:
a number of positive acknowledgments recognized in the sidelink;
a number of negative acknowledgements recognized in the sidelink;
a congestion status of a resource pool/band, e.g., determined based on sensing and/or based on a received message such as an assistance information message; and
a conflict information such as a number or ratio of past and/or future collision indications (CI) that are received in a resource pool, in a band and/or for a transmission block, TB or subchannel or for a set of resources or a single resource.
power measurement, interference power, CBR, RSRP, SNR, SINR etc. or other KPIs, e.g., measured on the DMRS symbols.

17. The device of claim 14, wherein the device is configured for receiving, from another device in the wireless communication network, a conflict information or inter-UE coordination information message (IuC) indicating at least a part of the channel condition.

18. The device of claim 14, wherein the device is configured for receiving a number of feedback messages, for evaluating the adaption of the evaluation parameter based on at least one of:
a slot or a time window where a feedback is transmitted, e.g., whether it is transmitted in the one or more reference slots/PSFCHs,
a reception of an sidelink control information, SCI, pointing to the said feedback, e.g., the control unit ignoring feedback if SCI was not received,
a signal strength and/or a proximity of SCI pointing to the feedback,
whether a negative acknowledgement, NACK, is assumed because feedback is not received or an actual NACK was detected, e.g., the control unit configured for increasing a time duration of a contention window based on a high number of received NACKs to reduce the channel load and decrease the chance of future collisions,
a cast-type of the associated transmission,
a destination device and/or a source device of the future transmission or of a channel indicator indicating the channel condition
a feedback which is transmitted to the said device,
a feedback which is transmitted to a group which the device belongs to,
a feedback which is transmitted by a certain device, comprising a (pre-) configured ID, e.g., a coordinating UE or RSU, group-lead UE or scheduling UE,
a pre-emption indication.

19. A wireless communication network comprising
a device according to claim 1.
